(19) United States
(12) Patent Application Publication
(10) Pub. No.: US 2024/0332664 A1
(43) Pub. Date: Oct. 3, 2024

(54) ELECTRIC VEHICLE BATTERY CONDITIONING

(71) Applicant: Zero Nox, Inc., Porterville, CA (US)

(72) Inventors: Robert Thomas Cruess, Porterville, CA (US); Vonn Robert Christenson, Porterville, CA (US); Dale Chi-Don Chiu, Hsinchu (TW); Zakary Tyler Smith, La Jolla, CA (US); Jacob Gotberg, Provo, UT (US)

(21) Appl. No.: 18/744,013

(22) Filed: Jun. 14, 2024

Related U.S. Application Data
(63) Continuation-in-part of application No. PCT/US2022/081594, filed on Dec. 14, 2022.
(60) Provisional application No. 63/290,610, filed on Dec. 16, 2021.
(60) Provisional application No. 63/290,604, filed on Dec. 16, 2021.

(51) Int. Cl. H01M 10/635; H01M 10/44; H01M 10/48; H01M 10/615; H01M 10/625; H01M 10/637

(52) U.S. Cl. CPC H01M 10/635; H01M 10/443; H01M 10/486; H01M 10/615; H01M 10/625; H01M 10/637

(57) ABSTRACT

A device may include a battery module configured to power a load. The device may include a precharge relay switch electrically connected between the positive node of the battery module and the load and in series with a precharge resistor. The device may include a negative relay switch electrically connected between a negative node of the battery module and the load. The precharge relay switch and the negative relay switch are set to a closed state and the positive relay switch is set to an opened state when an electrical connection to the load is detected at a first time, and the precharge relay switch is set to an opened state and the positive relay switch is set to a closed state at a second time when a difference between a voltage across the load and a voltage of the battery module satisfies a threshold difference.

### INCORPORATION BY REFERENCE

This application is a continuation-in-part of International Patent Application No. PCT/US2022/081594 filed on Dec. 14, 2022, which claims priority to U.S. Provisional Application No. 63/290,604, filed on Dec. 16, 2021, and U.S. Provisional Application No. 63/290,610, filed on Dec. 16, 2021, each of which is hereby incorporated by reference in its entirety herein for all purposes and made a part of the present specification. Any and all applications for which a foreign or domestic priority claim is identified in the Application Data Sheet as filed with the present application are hereby incorporated by reference under 37 CFR 1.57.

### TECHNICAL FIELD

The present disclosure relates to batteries, and more specifically to batteries used to power electric vehicles.

### BACKGROUND

Electric vehicles may include a battery pack that includes one or more battery modules formed from battery cells. The battery pack may be used output power that drives a motor of the electrical vehicle. In some cases, the battery pack may provide power for one or more additional systems of the electric vehicle, such as an air conditioning unit. The battery pack may further include one or more switches that are opened or closed based on whether the battery pack is supplying power, being charged, or not in use. Over time, the battery pack may degrade. In some cases, the battery pack may lose the ability to hold as much charge as when the battery pack was newer.

### SUMMARY

The systems, methods and devices of this disclosure each have several innovative aspects, no single one of which is solely responsible for all of the desirable attributes disclosed herein. Details of one or more implementations of the subject matter described in this specification are set forth in the accompanying drawings and the description below.

In some aspects, the techniques described herein relate to a temperature control system for regulating temperature inside a battery pack that includes a precharge circuit configured to protect low-voltage components during application of the battery pack to a load, the temperature control system including: a temperature sensor configured to measure ambient temperature within a battery enclosure of the battery pack, wherein the temperature sensor is positioned to measure the ambient temperature without measuring a temperature of a plurality of battery cells of the battery pack; a humidity sensor configured to measure humidity within the battery enclosure; and a controller configured to: receive a first temperature signal from the temperature sensor at a first time, wherein the first temperature signal corresponds to the ambient temperature measured by the temperature sensor; receive a first humidity signal from the humidity sensor, wherein the first humidity signal corresponds to the humidity measured by the humidity sensor; determine a first dew point based at least in part on the first temperature signal and the first humidity signal; determine based at least in part on the first dew point whether a heater threshold is satisfied; and in response to determining that the heater threshold is satisfied, activate the precharge circuit of the battery pack, wherein the precharge circuit modifies a temperature within the battery pack in place of a separate heating element.

In some aspects, the techniques described herein relate to a temperature control system, wherein the controller is further configured to: receive a second temperature signal from the temperature sensor at a second time, wherein the second temperature signal corresponds to the ambient temperature measured by the temperature sensor; receive a second humidity signal from the humidity sensor, wherein the second humidity signal corresponds to the humidity measured by the humidity sensor; determine a second dew point based at least in part on the second temperature signal and the second humidity signal; determine based at least in part on the second dew point whether the heater threshold is satisfied; and in response to determining that the heater threshold is not satisfied, deactivate the precharge circuit of the battery pack.

In some aspects, the techniques described herein relate to a temperature control system, wherein the controller is further configured to determine whether the heater threshold is satisfied based on the first dew point by determining whether a surface temperature in the battery pack satisfies the first dew point.

In some aspects, the techniques described herein relate to a temperature control system, further including a second temperature sensor configured to measure a battery cell temperature of a battery cell within the battery enclosure.

In some aspects, the techniques described herein relate to a temperature control system, wherein the controller is further configured to: receive a second temperature signal from the second temperature sensor at the first time, wherein the second temperature signal corresponds to the battery cell temperature measured by the second temperature sensor; and determine based at least in part on the first dew point and the second temperature signal whether the heater threshold is satisfied.

In some aspects, the techniques described herein relate to a temperature control system, further including a third temperature sensor configured to measure an environment temperature external to the battery pack.

In some aspects, the techniques described herein relate to a temperature control system, wherein the controller is further configured to: receive a third temperature signal from the third temperature sensor at the first time, wherein the third temperature signal corresponds to the environment temperature measured by the third temperature sensor; and determine based at least in part on the first dew point and the third temperature signal whether the heater threshold is satisfied.

In some aspects, the techniques described herein relate to a temperature control system, wherein the controller is further configured to determine whether the heater threshold is satisfied based at least in part on the first temperature signal, the first humidity signal, and a battery cell temperature.

In some aspects, the techniques described herein relate to a temperature control system, wherein the controller is further configured to determine whether the heater threshold is satisfied based at least in part on the first temperature signal, the first humidity signal, and an environment temperature external to the battery pack.

In some aspects, the techniques described herein relate to a temperature control system, wherein the humidity sensor is configured to measure relative humidity and wherein the humidity measured by the humidity sensor includes relative humidity.

In some aspects, the techniques described herein relate to a battery pack configured to power an electric vehicle, the battery pack including: a plurality of battery cells configured to store a charge and power a motor of the electric vehicle; a battery enclosure configured to house at least the plurality of battery cells; a precharge circuit configured to reduce a charge rate of a downstream capacitor; an ambient temperature sensor configured to measure ambient temperature within the battery enclosure; a relative humidity sensor configured to measure a relative humidity within the battery enclosure; and a controller configured to: determine, at a first time, a dew point based at least in part on the relative humidity and the ambient temperature; determine whether a surface temperature within the battery enclosure satisfies the dew point; and in response to determining that the surface temperature satisfies the dew point, activate the precharge circuit to modify the ambient temperature.

In some aspects, the techniques described herein relate to a battery pack, wherein the precharge circuit modifies the ambient temperature in place of a separate heating element.

In some aspects, the techniques described herein relate to a battery pack, further including a surface temperature sensor configured to measure the surface temperature within the battery enclosure.

In some aspects, the techniques described herein relate to a battery pack, wherein the surface temperature is a temperature of a wall of the battery enclosure.

In some aspects, the techniques described herein relate to a battery pack, wherein the surface temperature is a temperature of a battery cell of the plurality of battery cells.

In some aspects, the techniques described herein relate to a battery pack, further including an environment temperature sensor configured to measure an environment temperature of an environment external to the battery pack.

In some aspects, the techniques described herein relate to a battery pack, wherein the controller is further configured to determine the dew point based at least in part on the environment temperature.

In some aspects, the techniques described herein relate to a battery pack, wherein the controller is further configured to: determine, at a second time that is later than the first time, a second dew point based at least in part on a second relative humidity and a second ambient temperature; determine whether a second surface temperature within the battery enclosure satisfies the second dew point; and in response to determining that the second surface temperature does not satisfy the second dew point, deactivate the precharge circuit.

In some aspects, the techniques described herein relate to a method of regulating a battery pack, the method including: by a controller within the battery pack, measuring an ambient temperature within a battery enclosure of the battery pack using an ambient temperature sensor within the battery enclosure; measuring a relative humidity within the battery enclosure; determining a dew point based at least in part on the relative humidity and the ambient temperature; measuring a surface temperature within the battery enclosure, wherein the surface temperature corresponds to a temperature of a surface within the battery enclosure; determining whether the surface temperature satisfies the dew point; and in response to determining that the surface temperature satisfies the dew point, activating a precharge circuit within the battery pack, wherein the precharge circuit is activated to modify a temperature.

In some aspects, the techniques described herein relate to a method, wherein the precharge circuit is used in place of at least one heating element, and wherein the at least one heating element is omitted from the battery pack.

In some aspects, the techniques described herein relate to a temperature control system for regulating temperature inside a battery pack, the temperature control system including: a heating element configured to raise a temperature of an ambient environment within a battery enclosure of the battery pack; a first temperature sensor configured to measure a first temperature of the ambient environment at a first measurement location within the battery enclosure, wherein the first temperature sensor is attached to a first attachment location within the battery enclosure and at a first distance away from a plurality of battery cells of the battery pack; a second temperature sensor configured to measure a second temperature of the ambient environment at a second measurement location within the battery enclosure, wherein the second temperature sensor is attached to a second attachment location within the battery enclosure and at a second distance away from the plurality of battery cells of the battery pack; and a controller configured to: receive a first temperature signal from the first temperature sensor at a first time, wherein the first temperature signal corresponds to a first temperature of the ambient environment at the first time and at the first measurement location; receive a second temperature signal from the second temperature sensor at the first time, wherein the second temperature signal corresponds to a second temperature of the ambient environment at the first time and at the second measurement location; determine an average ambient temperature based at least in part on the first temperature signal and the second temperature signal; compare the average ambient temperature to a threshold temperature value to obtain a comparison result; and based at least in part on the comparison result, activate the heating element to raise the temperature of the ambient environment within the battery enclosure from the average ambient temperature to a target temperature.

In some aspects, the techniques described herein relate to a battery pack configured to power an electric vehicle, the battery pack including: a plurality of battery cells configured to store a charge and power a motor of the electric vehicle; a battery enclosure configured to house at least the plurality of battery cells; and a temperature control system stored within the battery enclosure and configured to regulate ambient temperature inside the battery enclosure, the temperature control system including: a heating element configured to raise the ambient temperature within the battery enclosure; a temperature sensor configured to measure the ambient temperature within the battery enclosure, wherein the temperature sensor is positioned to measure the ambient temperature without measuring a temperature of the plurality of battery cells; and a controller configured to: receive a temperature signal from the temperature sensor at a first time, wherein the temperature signal corresponds to the ambient temperature within the battery enclosure at the first time; compare the ambient temperature to a threshold temperature value based at least in part on the temperature signal to obtain a comparison result; and based at least in part on the comparison result, activate the heating element to raise the ambient temperature within the battery enclosure at a second time.

In some aspects, the techniques described herein relate to a method of regulating temperature inside a battery pack, the method including: by a controller of the battery pack, receiving a temperature signal from a temperature sensor at a first time, wherein the temperature signal corresponds to an ambient temperature within a battery enclosure of the battery pack at the first time; comparing the ambient temperature, based at least in part on the temperature signal, to a threshold temperature value to obtain a comparison result; and based at least in part on the comparison result, activating a heating element to raise the ambient temperature within the battery enclosure at a second time without modifying heat applied to a plurality of cells of the battery pack.

In some aspects, the techniques described herein relate to a battery pack configured to precharge a load, the battery pack including: a battery module configured to electrically connect to the load that is powered by the battery module; a positive relay switch electrically connected between a positive node of the battery module and the load; a precharge relay switch electrically connected between the positive node of the battery module and the load, wherein the precharge relay switch is connected in parallel with the positive relay switch; a precharge resistor connected between the precharge relay switch and the positive node of the battery module; and a negative relay switch electrically connected between a negative node of the battery module and the load, wherein the precharge relay switch and the negative relay switch are set to a closed state and the positive relay switch is set to an opened state when an electrical connection to the load is detected at a first time, and wherein the precharge relay switch is set to an opened state and the positive relay switch is set to a closed state at a second time.

In some aspects, the techniques described herein relate to an electric vehicle including: a motor; and a battery pack configured to power the motor, the battery pack including: a battery module configured to electrically connect to a capacitor of the motor; a positive relay switch electrically connected between a positive node of the battery module and the capacitor; a precharge relay switch electrically connected between the positive node of the battery module and the capacitor, wherein the precharge relay switch is connected in parallel with the positive relay switch; a precharge resistor connected between the precharge relay switch and the positive node of the battery module; and a negative relay switch electrically connected between a negative node of the battery module and the capacitor, wherein the precharge relay switch and the negative relay switch are set to a closed state and the positive relay switch is set to an opened state when an electrical connection to the capacitor is detected at a first time, and wherein the precharge relay switch is set to an opened state and the positive relay switch is set to a closed state at a second time.

In some aspects, the techniques described herein relate to a method of discharging a battery pack to power a load of an electric vehicle, the method including: determining that the battery pack has been connected at a first time to a load of the electric vehicle; responsive to the determination at the first time: maintaining in an open position a charge relay switch positioned between a positive node of a battery module of the battery pack and a port configured to electrically connect to a battery charging system; maintaining in a closed position a precharge relay switch positioned between a precharge resistor and the load of the electric vehicle, wherein the precharge resistor is positioned between the precharge relay switch and the positive node of the battery module; maintaining in an open position a positive relay switch positioned in parallel with the precharge relay switch and connected between the positive node of the battery module and the load of the electric vehicle; and maintaining in a closed position a negative relay switch connected between the load of the electric vehicle and a negative node of the battery module; determining at a second time that a trigger condition has been satisfied; and in response to determining that the trigger condition has been satisfied, opening the precharge relay switch and closing the positive relay switch.

Although certain embodiments and examples are disclosed herein, inventive subject matter extends beyond the examples in the specifically disclosed embodiments to other alternative embodiments and/or uses, and to modifications and equivalents thereof.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure. In addition, various features of different disclosed embodiments can be combined to form additional embodiments, which are part of this disclosure. Further, one or more features or structures can be removed or omitted.

FIG. 1 illustrates an example of a battery pack with a precharge device circuit in accordance with certain embodiments.

FIG. 2 illustrates an example circuit diagram of the battery pack of FIG. 1 with the precharge device circuit in accordance with certain embodiments.

FIG. 3 presents a flowchart of an example battery discharge process in accordance with certain embodiments.

FIG. 4 presents a flowchart of an example battery charging process in accordance with certain embodiments.

FIG. 5 illustrates a block diagram of an example operating environment of an example energy storage management system in accordance with certain embodiments.

FIG. 6 illustrates a block diagram of an example energy storage management system in accordance with certain embodiments.

FIG. 7A illustrates an example energy storage device in accordance with certain embodiments.

FIG. 7B illustrate various views of an example energy storage device with an example temperature control devices in accordance with certain embodiments.

FIG. 7C illustrates attachment of an example temperature control device within a battery enclosure of a battery pack in accordance with certain embodiments.

FIG. 8A and FIG. 8B illustrate example wiring for temperature control devices for energy storage devices in accordance with certain embodiments.

FIG. 8C illustrates an example relay control wiring for temperature control devices in accordance with certain embodiments.

FIG. 9 illustrates a schematic diagram of an example temperature control devices in accordance with certain embodiments.

FIG. 10 illustrates an example user interface display for an example energy storage management system in accordance with certain embodiments.

FIG. 11 illustrates an example ambient temperature modification process in accordance with certain embodiments.

FIG. 12 illustrates an example battery environment regulation process in accordance with certain embodiments.

### DETAILED DESCRIPTION OF CERTAIN EMBODIMENTS

The headings provided herein, if any, are for convenience only and do not necessarily affect the scope or meaning of the claimed invention.

### Introduction

An electric vehicle may be powered by a battery pack composed of multiple battery modules, which may be connected in series and may include a number of battery cells. The voltage output by the battery pack may be relatively high compared to some of the elements powered by the battery pack. For example, the battery pack may have a voltage of more than 400 volts. In some cases, the voltage may be between 400 and 800 volts or even higher. This high voltage may cause a large current to flow immediately or shortly after the battery pack is turned on or is connected to the electric vehicle (e.g., to the motor of the electric vehicle). For example, the current flow may be between 50 and 500 Amps. The relatively large current flow at the point in time when the battery pack is turned on or connected to the load (e.g., the motor or an air conditioning unit, etc.) may damage low-voltage components immediately or over time. For example, 5-, 12-, or 24-volt components may be damaged by the large current flow of an 800-volt battery.

To protect the low-voltage components and the battery pack, the battery pack may include a precharge circuit. This precharge circuit may include one or more switches or relays that can control the current flow of the battery pack and help protect the low-voltage components. In some cases, the large current flow may damage the one or more switches. In certain embodiments, a resistance may be included as part of the precharge circuit to protect a precharge switch. Upon detecting that a voltage of the load is within a threshold of the battery voltage, a battery management unit may disconnect the precharge circuit and permit direct discharge of the battery pack to power the load without the precharge circuit.

Further, the charge stored by battery pack may be impacted by the temperature of the battery pack and/or the environment in which the battery pack operates. The use of a heater can raise the temperature of the battery pack to improve operation of the battery pack and to increase the available charge within the battery pack and/or to reduce the impact of cold temperatures on the charge storage within the battery pack. The heater may be activated when the temperature within the battery pack is below a particular threshold temperature (e.g., below 68° F., 60° F., 50° F., 45° F., 40° F., etc.). However, operation of the battery pack itself may generate heat that can cause the heat on the battery modules or battery cells itself to be above the threshold temperature. As a result, even when the temperature around the battery, or within the battery pack is below the threshold temperature, the heat of the battery cells themselves may cause the heater to not be activated or prevent the heater from being activated. Thus, a battery pack operating at normal temperature that may last for 300 miles of driving may only operate for 200 miles or less when operating in cold temperature.

Some electric vehicle battery pack heating systems may include a radiator, a water pump, water supply pipes, water return pipes and a motor. Further, battery pack walls can include insulation layers. During winter seasons, the radiator is in the battery box (which may house one or more battery packs, which may each house one or more battery modules and/or battery cells) and uses the heat emitted by the motor and supplied to the radiator by the water supply pipe and water pump to warm the battery pack. The radiator increases the temperature of the battery box to protect the battery (for example, preventing the excessive power consumption due to the low temperature) and increases the driving range of an electric vehicle. During warm seasons, the radiator may be outside the battery box to protect batteries in the battery pack by cooling the batteries. As explained above, sometimes the temperature sensed at the positive and negative sides or terminals of the battery pack does not trigger the heating and cooling device when needed because, for example, charging or discharging of the battery can warm the battery cells themselves. Further, operation costs associated with a radiator-based heating system to control temperature of battery packs can be quite high. As such, there is a need for an efficient method of detecting and maintaining battery temperature that addresses the above. In addition, there is a need to control the humidity of air surrounding the battery packs to reduce corrosion of various battery pack components (for example, copper bars) to improve performance and service life of battery packs.

To improve operation of the battery, embodiments disclosed herein use a temperature sensor that is configured to measure the ambient or environment temperature within the battery pack. The temperature sensor may be located away from the battery cells preventing or reducing the impact of heat generated by the battery cells from the temperature measurement. For example, the temperature sensor may be positioned on the sides of the battery pack or on the upper part of the battery pack (e.g., on a top plate or on an inside cover) away from the battery cells or the terminals of the battery cells that may generate heat. Further, embodiments disclosed herein may use an electric Positive Temperature Coefficient (PTC) heating plate, which may be more efficient to operate than a system that uses a radiator, a water pump, water supply pipes, water return pipes and a motor to move heat.

In certain use cases, the electric vehicle batteries may be used in electric vehicles that are operated in cold environments (e.g., 55° F. or less). These environments may not only include external cold weather locations, but may also include cold internal locations, such as cold storage warehouses or refrigerated warehouses. Cold storage warehouses may be maintained at 55° F. or less. In some cases, cold storage warehouses may be as cold as −30° F.

Many existing electric vehicle batteries used in cold environments (e.g., cold storage warehouses) last for 4 hours or less. As such, it is often necessary to exchange battery packs used in electric vehicles (e.g., forklifts, carts, or other electric warehouse vehicles) at least once if not more during a single shift (e.g., 8 to 12 hours). Advantageously, embodiments of the present disclosure, for a battery of the same size as existing electric vehicle batteries, extend the use of the battery pack from 4 hours to as much as 10 hours or more enabling a single battery to be used in some cases for an entire shift.

### Example Precharge Device Circuit

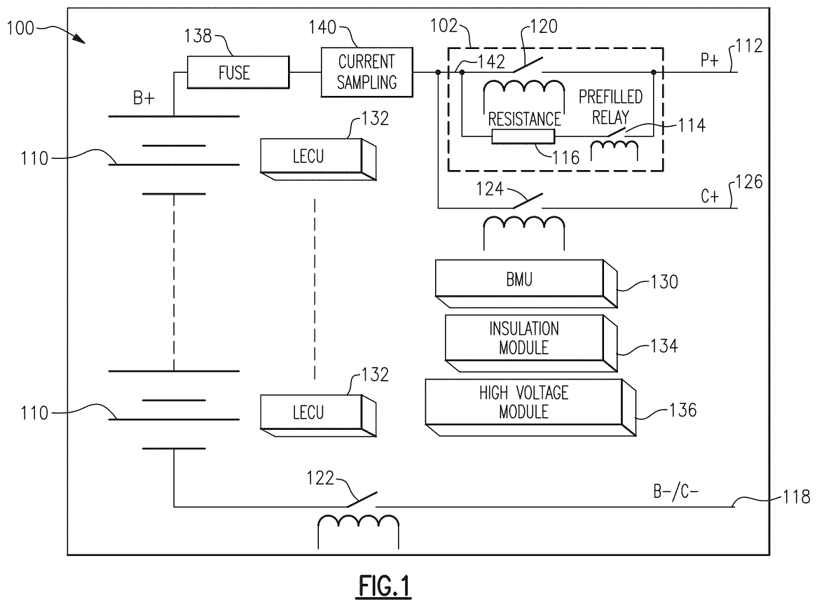

FIG. 1 illustrates an example of a battery pack 100 with a precharge device circuit in accordance with certain embodiments. The battery pack 100 includes one or more battery modules 110 that may be or may include one or more battery cells. When the one or more battery modules 110 includes a plurality of battery modules 110, the battery modules 110 may be connected in series. The one or more battery modules 110 may be used to supply power to an electric vehicle or one or more components of an electric vehicle, such as a motor, an air conditioner, or other systems that may be included in the electric vehicle. The battery pack 100 may be a lithium ion, a lithium iron or lithium iron phosphate, lithium polymer, or any other type of battery that may be used to power an electric vehicle.

The battery pack 100 may include both a charge path and a discharge path. The discharge path is used to supply power from the one or more battery modules 110 to the elements of the electric vehicle being powered by the battery pack 100. In other words, discharging the battery pack 100 may be the same as powering a device or load using the battery pack 100. In some cases, there may be multiple discharge paths (e.g., a discharge path for precharging and a discharge path after precharging is complete). The charge path is used to supply power to the one or more battery modules 110 to recharge the battery pack 100.

The discharge path may include a precharge device circuit 102 that connects a positive node or positive pole of the one or more battery modules 110 to a load (e.g., a motor) via a P+ connection node 112. The precharge device circuit 102 includes a precharge relay switch 114 in series with a resistance 116. The precharge relay switch 114 may also be referred to as a prefilled relay. The resistance 116 may include one or more resistors or resistor networks. Further, the resistance 116 may help protect the precharge relay switch 114 from the high current that flows upon connection of the load to the battery pack 100. When a load is connected to the battery pack 100, a battery management unit 130 may cause the precharge relay switch 114 to close. Alternatively, or in addition, the precharge relay switch 114 may automatically close responsive to connection of the battery pack 100 with a load. The resistance 116 reduces the current that flows over the precharge relay switch 114 when the precharge relay switch 114 is first closed reducing or preventing damage that may occur to the switch over time. Further, the reduction in current may protect the low voltage elements of the load. For instance, a capacitor in electrical communication with the battery pack 100 between the connection node 112 and the connection node 118 (e.g., the B-/C-connection node) may be damaged when connected to the high voltage battery pack 100. The use of the precharge relay switch 114 and resistance 116 may protect the capacitor from the high current that flows when initially connected to the battery pack 100. Thus, the inclusion of the resistance 116 can protect both the precharge relay switch 114 and the load from damage that may be caused by the immediate or instantaneous high voltage and high current of the battery pack 100 when the battery pack 100 is connected to the load.

The battery pack 100 may further include a positive relay switch 120. The positive relay switch 120 may be part of the discharge path of the battery pack 100. Although part of the discharge path, the positive relay switch 120 may be separate from the precharge device circuit 102. Alternatively, the positive relay switch 120 may also be considered part of the precharge device circuit 102 and may be connected in parallel with the precharge relay switch 114. When the battery pack 100 is connected to a load (e.g., a motor), the positive relay switch 120 may initially be open. The positive relay switch 120 may remain open at least until a precharge process is completed. When a voltage across the load approaches or is within a threshold voltage of the voltage across the one or more battery modules 110, the precharge relay switch 114 may be set to an opened state, while the positive relay switch 120 may be closed. Further, a negative relay switch 122 may be closed when the battery pack 100 is connected to a load.

It should be understood that the battery pack 100 may be physically connected to a load, but may not be electrically connected to a load during particular periods of time. For example, the battery pack 100 may be in an electric vehicle along with a motor. The battery pack 100 may be at least partially connected to the motor, or to other devices within the electric vehicle that also connect to the motor. However, a switch or electrical contact may be open preventing an electrical connection from being formed until such time as the switch or electrical contact is closed (e.g., when a key is inserted into a starter, or when an ignition or start process if performed). As used herein, unless stated otherwise, connecting the battery pack 100 to a load refers to establishing an electrical connection such that current may flow from the battery pack 100 to the load, or vice versa in the case of charging the battery pack 100.

The precharge relay switch 114 may remain open and the positive relay switch 120 may remain open at least until such time as a voltage across the load approaches or within the threshold voltage of the voltage across the one or more battery modules 110. The threshold voltage may be within 50%, 60%, 70%, 80%, 90%, 95%, or greater of the voltage of the one or more battery modules 110, or any voltage value in between. In some cases, the precharge relay switch 114 may remain open and the positive relay switch 120 may remain closed at least until a trigger condition is satisfied. The trigger condition may include the voltage across the load satisfying the threshold voltage (e.g., voltage of the one or more battery modules 110), a fixed or particular period of time elapsing, or a fixed or particular period of time elapsing after the voltage across the load satisfies the threshold voltage. The particular period of time may include any period of time, but is generally selected to provide sufficient time for the load or an output capacitor to reach a particular voltage such that damage to the capacitor and/or the relays are reduced or eliminated. In some cases, the fixed period of time may be 0.25 seconds, 0.5, seconds, 1 second, 2 seconds, or more or any time period in between.

The battery pack 100 may further include a charge relay switch 124. The charge relay switch 124 may form part of the charge path and may be closed when the battery pack 100 is connected to a battery charging system (not shown) for charging the battery pack 100. The negative relay switch 122 may form both part of the discharging path and the charging path and may be closed both when the battery pack 100 is discharging (e.g., powering a load) and when the battery pack 100 is being charged. The battery charging system may be connected between the connection node 118 and a connection node 126. The negative relay switch 122 may be open when the battery pack 100 is not connected (or electrically connected) to a load or to a battery charging system. When it is determined, e.g., by the battery management unit 130, that an electrical connection has been formed with the load or the battery charging system, the negative relay switch 122 may be closed.

Each of the switches or relays (e.g., the positive relay switch 120, the precharge relay switch 114, the charge relay switch 124, and/or the negative relay switch 122, which may collectively be referred to as “relay switches” or individually as a “relay switch”) may be the same type of switch or relay. Alternatively, at least one of the switches or relays may differ from at least one other of the switches or relays. In some cases, the switches may be an inductor relay, a mechanical switch, a transistor switch, or any other type of switch or relay that may be used to control current flow within a battery pack 100 and/or between a battery pack 100 and a connected load. In cases where the illustrated switches are relays, the depicted inductor coils may be connected to a control switch. The control switch may cause the relays to transition from an open state to a closed state upon the control switch being closed. Each relay may be connected to a separate control switch. In some cases, the control switch may be controlled by the battery management unit 130. In other cases, the control switches may be part of the battery management unit 130. Further, in some cases, the control switches may be powered by the one or more battery modules 110 of the battery pack 100. However, in other cases, the control switches may be powered by a separate battery of the electric vehicle, such as a 12-volt battery that may be used to power at least some electronics of the electric vehicle and/or to initiate operation of the electric vehicle including, in some cases, the battery management unit 130.

The battery pack 100 may further include the battery management unit 130, which may also be referred to as a battery management system. The battery management unit 130 may control the state of the switches (e.g., the positive relay switch 120, the precharge relay switch 114, the charge relay switch 124, and/or the negative relay switch 122, among others not shown). The battery management unit 130 may include a relay detection capability that can detect and confirm states of one or more of the relay switches when the pre-charge operation is started (e.g., at the point in time when the battery pack 100 is first connected to a load that it is powering or when a start or initialization process for the electric vehicle is performed after a period of non-use). Further, the battery management unit 130 may control whether the battery pack 100 electrically connects to a load or a battery charging system when (or at some later point in time) it is determined that a physical connection to the load or the battery charging system is or has been established.

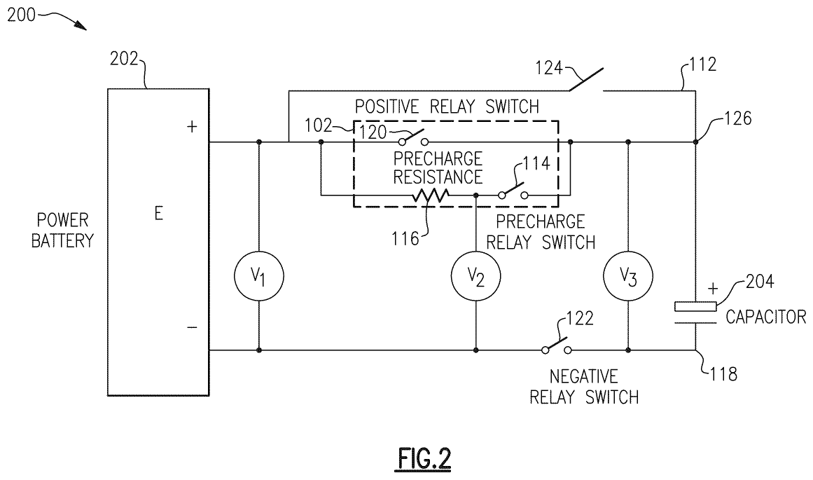

In some embodiments, the precharge device circuit 102 may protect low-voltage components of the battery management unit 130 from being damaged. The precharge device circuit 102 may further include a capacitor (depicted in FIG. 2) at the charging and discharging ends of the battery pack 100. The capacitor may be connected between the connection node 112 and the connection node 118. Further, the capacitor can reduce or prevent damage to one or more of the switch relays and/or the low-voltage components of the battery management unit 130 by the impact of large currents that may be generated when the battery pack 100 is connected to a load. The precharge device circuit 102 may further protect any other system susceptible to large currents in the battery pack 100 and/or connected to the battery pack 100. For example, the precharge device circuit 102 may protected the battery management unit 130, one or more DC-DC circuits, one or more relay switches, etc.). Further, the precharge device circuit 102 can protect one or more low-voltage components of the load connected to the battery pack 100 including different types of vehicles (e.g., different electric cars or utility vehicles including forklifts, tractors, etc.), different components of the vehicle (e.g., motor, air conditioning, etc.), and the like.

The battery pack 100 may additionally include one or more local electrical control units 132, an insulation module 134, and a high voltage module 136. The one or more local electrical control units 132 may correspond in number to the number of battery modules 110 included in the battery pack 100 with each local electrical control unit (LECU) associated with a corresponding battery module. Each of the one or more local electrical control units 132 may measure a state of the corresponding battery module 110, control operations of the corresponding battery module 110, and provide a status (e.g., current, voltage, temperature, etc.) of the corresponding battery module to the battery management unit 130. In some cases, the combination of the battery management unit 130 and the one or more local electrical control units 132 may form the battery management system.

The insulation module 134 and the high voltage module 136 may include one or more protective layers or circuit elements configured to isolate and protect users from large currents that may be generated by a high voltage battery.

The battery pack 100 may further include a fuse 138 and a current sampling circuit 140. The fuse 138 may provide overcurrent protection for the battery pack 100 and/or the load connected to the battery pack 100. Further, the current sampling circuit 140 may measure a current across the discharge path and may provide the current measurement to the battery management unit 130. In some cases, the battery management unit 130 may cause the current value to be displayed to a user as part of a user interface.

FIG. 2 illustrates an example circuit diagram of the battery pack 100 of FIG. 1 with the precharge device circuit 102 in accordance with certain embodiments. The battery pack circuit 200 include a battery module 202 that may include the one or more battery modules 110. Further, the battery pack circuit 200 may include one or more of the relay switches illustrated with respect to FIG. 1. In addition, the battery pack circuit 200 may include a capacitor 204, which may be a reserve capacitor. As explained above, the capacitor 204 can reduce or prevent damage to one or more of the switch relays and/or the low-voltage components of the battery management unit 130 by the impact of large currents that may be generated when the battery pack 100 is connected to a load. Further, the capacitor 204 may be charged by the battery module 202 bringing the voltage across the capacitor 204 at or near the voltage level of the battery module 202. Once the voltage across the capacitor 204 nears or is within a threshold voltage of the battery module 202, the battery management unit 130 may cause the precharge relay switch 114 to be opened and the positive relay switch 120 to be closed. The battery pack circuit 200 illustrates three voltages within the circuit. V₁ may represent the battery voltage, E, V₂ may represent the voltage across the resistance 116, and V₃ may represent the output voltage or the voltage across the capacitor 204. In some embodiments, the capacitor 204 may be or may represent a capacitor of a load connected to the battery pack circuit 200. Further, the capacitor 204 may be a capacitor bank or a network of capacitors. The capacitor 204 may be a non-polar capacitor. The capacitor 204 size may vary based on the battery pack 100 and/or the load powered by the battery pack 100. In some cases, the capacitor may be any size between 1 μF and 10,000 μF. However, it is possible for the capacitor to be larger or smaller based on the battery pack 100 and/or the load powered by the battery pack 100.

### Example Battery Discharge Process

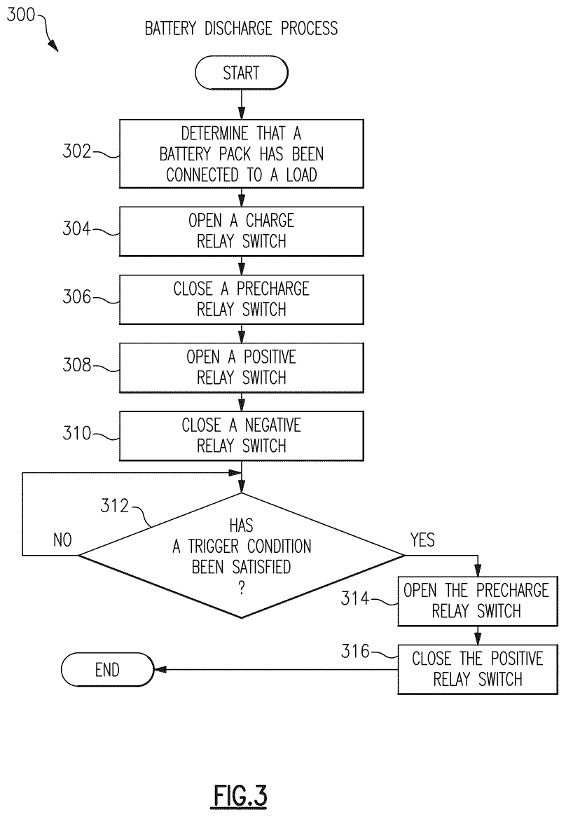

FIG. 3 presents a flowchart of an example battery discharge process 300 in accordance with certain embodiments. The battery discharge process 300 may be performed in response to a physical or electrical connection being formed between a battery pack 100 (or battery pack circuit 200) and a load that is powered by the battery pack 100 (or the battery pack circuit 200), such as a motor, air conditioning unit, some other electric vehicle component, or any other component powered by a battery. The battery discharge process 300 may be performed by any device or system that can control operation of a battery pack 100 (or battery pack circuit 200) including, for example, a battery management unit 130. In some cases, one or more operations of the battery discharge process 300 may be performed automatically or in response to a load being connected to the battery pack 100 (or battery pack circuit 200). In some cases, a handshaking or connection process between the battery pack 100 and the load may trigger performance of the battery discharge process 300.

The battery discharge process 300 may begin at the block 302 where, for example the battery management unit 130, determines that a battery pack 100 has been connected to a load, such as a motor or air conditioner. In some cases, there may be multiple loads connected to the battery pack 100. The block 302 may include performing a handshaking process to determine that the load is connected to the battery pack 100. For example, the battery management unit 130 of the battery pack 100 may perform a handshaking process to determine that the load is physically and/or electrically connected to the battery pack 100 or to a port of the battery pack 100.

As part of the battery discharge process 300, precharging (e.g., of the capacitor 204) is performed to protect low-voltage components and the relays of the electric vehicle and/or of the battery pack 100. The precharging may be performed by implementing the operations of the battery discharge process 300 described below. The process may be initiated in response to the operations at the block 302 determining that the load is physically or electrically connected to the battery pack 100, or otherwise connected in a manner that enables the load to draw power from the battery pack 100. The determination of whether the load is connected to the battery pack 100 may be based at least in part on the handshaking process between the battery pack 100, or the battery management unit 130 of the battery pack 100, and the load. Alternatively, or in addition, the battery management unit 130 may determine to configure the relays (e.g., the precharge relay switch 114, positive relay switch 120, and/or the negative relay switch 122) of the battery pack 100 to supply power to the load in response to determining that there is no fault in battery pack 100 or the connection to the battery pack 100 based on a self-test process. The battery management unit 130 may receive a low voltage power signal that enables the battery management unit 130 to close a hold relay and perform the self-test. If no faults are detected during the self-test, the battery management unit 130 may close the negative relay switch 122 and initiate the pre-charging process. Thus, in some cases, the block 310 described below may be performed after determining that there are no faults in the system.

At block 304, the battery discharge process 300 involves opening a charge relay switch 124. The operations associated with the block 304 may be performed by the battery management unit 130. The battery management unit 130 may be configured to open or close each of the relays or switches disclosed herein including, the hold relay, the precharge relay switch 114, positive relay switch 120, negative relay switch 122, and charge relay switch 124. The charge relay switch 124 may be part of a charging path used to charge the battery pack 100 when the battery pack 100 is connected to a battery charging system. Thus, the charge relay switch 124 may be opened when the battery pack 100 is not being charged but is being used to power a load. In some cases, the charge relay switch 124 may already be open and the operations associated with the block 304 may be omitted. In some cases, the charge relay switch 124 may already be open. In such cases, the block 304 may involve maintaining the charge relay switch 124 in an open position or an off state.

At block 306, the battery discharge process 300 involves closing a precharge relay switch 114, or maintaining the precharge relay switch 114 in a closed or on state. At block 308, the battery discharge process 300 involves opening a positive relay switch 120. Alternatively, or in addition, the block 308 may include maintaining the positive relay switch 120 in an open or off state. At block 310, the battery discharge process 300 involves closing a negative relay switch 122. In some cases, the precharge relay switch 114 and the negative relay switch 122 may already be closed, and the positive relay switch 120 may already be open. In such cases, the blocks 306, 308, and 310 may involve maintaining the switches in their open (or off) or closed (or on) states. Closing the precharge relay switch 114 and the negative relay switch 122 may put the capacitor 204 and/or a load into a charging state, and the precharge current across the resistance 116 may be calculated as Ip=(Vb−Vc)/R where R is the resistance of resistance 116, Vb is the voltage at the node 142 and Vc is the voltage at the connection node 112. As the voltage at both ends of the capacitor 204 slowly increases, ΔV (Vb-Vc) will be small and the pre charging current Ip is very small, which ensures the safety of the precharge device circuit 102. The capacitor 204 may be a bus capacitor. The bus capacitance may refer to the input capacitance of a motor controller (e.g., because it may be the largest capacitance, while the input capacitance of the DC-DC circuit may be very small, on the order of tens of μF), which is about 600 μF, and may be selected according to the load.

When the precharge device circuit 102 is in the off state (e.g., before the battery pack 100 has been connected to a load), the output voltage V₃ (the voltage across the capacitor 204) is 0. If the battery voltage is represented by E, then the initial charging current is E/R when the battery charges the capacitor 204 through the resistance 116. As one nonlimiting example, assume that E is a series of 24 lithium iron phosphate batter cells (e.g., 24 battery modules 110 connected in series), the maximum voltage is 3.65V*24=87.6V. Further, suppose that the value of the capacitor 204 is C=10000 μF.

As a nonlimiting example, if the resistance 116 is selected to be R=50 ohm, the charging time constant=R*C=50*10000*10\hat{ }(−6)=0.5 seconds. The instantaneous current at the start of charging is 87.6/50=1.752 amps, and the instantaneous power at R is 1.752*1.752*50=153 W. However, after 5 time constants (2.5 sec), E−V₃=0.590 volts. Further, the charging current is reduced to 0.012 A and the power on the R is also reduced to 0.01 W, with the average power consumption of the resistance in 2.5 sec being 18.62 W. After 10 time constants (5 sec), E−V₃=0.004V, the charging current is reduced to 0.000 A, the power on R is also reduced to 0.00 w, and the average power consumption of the resistor in 5 sec is 9.31 W. As the difference between the battery voltage, E, and the output voltage, V₃, is relatively small (e.g., less than a volt), the precharge relay switch 114 can be opened and the positive relay switch 120 may be closed enabling the battery pack 100 to power the load (e.g., a motor) without damaging any low voltage components, the capacitor 204, or any of the relay switches. The battery management unit 130 may determine whether to disengage the precharge device circuit 102 (e.g., open the precharge relay switch 114) based at least in part on the difference between the battery voltage, E, and the output voltage, V₃. If the difference is less than a threshold, the battery management unit 130 may open the precharge relay switch 114 and close the positive relay switch 120. This threshold may be 0.5 volts, 1 volt, 5 volts or some relatively small voltage compared to the voltage of the battery cells and/or the voltage supported by the load.

As another nonlimiting example, if the resistance 116 is selected to be R=100 ohm, the charging time constant=R*C=100*10000*10\hat{ }(−6)=1.0 sec. The instantaneous current at the start of charging is 87.6/100=0.876 A, and the instantaneous power at R is 0.876*0.876*100=76.74 W. However, after five time constants (5 sec), E−V₃=0.590 volts, the charging current is reduced to 0.006 A, the power on R is also reduced to 0.00 W, and the average power consumption of the resistor within 5 s is 8.47 W. After 10 time constants (10 sec), E−V₃=0.004V, the charging current is reduced to 0.000 A, the power on R is also reduced to 0.00 W, and the average power consumption of resistor in 10 sec is 4.23 W. As with the previous example, as the difference between the battery voltage, E, and the output voltage, V₃, is relatively small (e.g., less than a volt), the precharge relay switch 114 can be opened and the positive relay switch 120 may be closed enabling the battery pack 100 to power the load (e.g., a motor) without damaging any low voltage components, the capacitor 204, or any of the relay switches.

As the battery pack 100 powers the load, resistance will increase. Therefore, when a large current flows, a large amount of heat will be generated at the output contacts (e.g., at connection node 118 and connection node 126) and the contacts will be fused together. One way to solve this problem is to connect a non-polar capacitor at both ends of the contact (e.g., the capacitor 204). Because of the extremely fast voltage change between the two contacts, the capacitor will bypass the high voltage which will be triggered by it with a large current according to the characteristic of I=C (DV/DT), thus inhibiting the generation of sparks. The capacity of the capacitor 204 may be 100 A or more corresponding to 1 μF or greater, and can withstand voltage of more than 3 times the voltage of the battery pack 100. The size of the resistor, R, may vary based on the voltage of the battery pack. For example, the resistor may be anywhere between 100 ohm and 100 kiloohms. However, the size of the resistor may be smaller or greater depending on the voltage of the battery pack.

Through use of the precharge device circuit 102, the battery pack 100 can prevent the capacitor 204 from being in the saturated state, and can provide over-current protection, protect the capacitor 204, extend the service life of the capacitor 204, which can improve the working reliability of one or more of the relay switches. Further, the precharge device circuit 102 has minimal to no drain on the one or more battery modules 110 and can prolong the driving mileage of the electric vehicle that uses the battery pack 100.

At decision block 312, the battery discharge process 300, using for example the battery management unit 130, involves determining whether a trigger condition has been satisfied. The trigger condition may include determining whether a voltage across the load (e.g., the capacitor 204) satisfies a threshold or is within a threshold voltage of the battery voltage. For example, the decision block 312 may involve determining whether a difference between the voltage across the load, V₃, and the battery voltage, E, is less than a threshold voltage. In some cases, the trigger condition may be the passage of a particular or fixed period of time (e.g., 0.25 s, 0.5 s, 1.0 s, 1.5 s, etc.). In yet other cases, the trigger condition may be the passage of the particular or fixed period of time after a determination that the voltage across the load matches or differs by less than a threshold from the battery voltage. As stated above, the load may be the capacitor 204. Alternatively, or in addition, the load may include any device connected to the battery pack 100 that is being powered by the battery pack 100. Determining whether the voltage across the load is within a threshold voltage of the battery voltage may involve determining whether the voltage across the load and the battery voltage are the same, or that a difference between the two voltages is less than a threshold amount.

If it is determined at the decision block 312 that the trigger condition has not been satisfied, the battery discharge process 300 may repeat operations associated with the decision block 312 continuously, periodically, or in response to a trigger, such as a command from the battery management unit 130. The operations associated with the decision block 312 may be repeated until the trigger condition has been satisfied or until the battery discharge process 300 is interrupted (e.g., disconnection of the battery pack 100 from the load, or detection of an error condition).

If it is determined at the decision block 312 that the trigger condition has been satisfied, the battery discharge process 300 may proceed to block 314 where the battery discharge process 300, using for example the battery management unit 130, involves opening the precharge relay switch 114. At block 316, the battery discharge process 300 involves closing the positive relay switch 120. Thus, at a first time, the precharge device circuit 102 (e.g., the precharge relay switch 114) may be closed and the positive relay switch 120 may be open. Then at a second time when the voltage of the load, or the capacitor 204, approaches or matches the voltage of the battery modules 110, and/or a particular time has elapsed, the precharge device circuit 102 (e.g., the precharge relay switch 114) may be opened and the positive relay switch 120 may be closed.

In some embodiments, operations associated with one or more of the blocks may be performed in a different order or at least partially in parallel. For example, operations associated with the blocks 304, 306, 308, and 310 may be performed in a different order, simultaneously, or at least partially in parallel. For instance, in some cases, the operations associated with the block 310 may be performed first or prior to the operations associated with the blocks 306. As another example, the blocks 314 and 316 may be performed in a different order or substantially in parallel. Further, in some embodiments, one or more of the operations associated with one or more of the blocks may be omitted because, for example, the relay switches are already in the desired state. For example, in some cases, the charge relay switch 124 may already be open as the battery pack 100 may, for example, not be connected to battery charging system and thus, the block 304 may be omitted.

In some embodiments, the process 300 may include performing a self-test to check for faults, errors, or damage before electrically connecting the battery pack 100 to the load. Thus, in some cases, after the vehicle supplies a low voltage power to the battery management unit 130, the battery management unit 130 may close a hold relay. If there is no fault detected during the self-test process, the battery management unit 130 may first close the negative relay switch 122, and then close the precharge relay switch 114. After the precharge process is completed (e.g., the trigger condition has been satisfied as determined at the decision block 312), the battery management unit 130 may close the positive relay switch 120, and then disconnect the precharge relay switch 114 after 0.5 s. The use of the precharge device circuit 102 (e.g., the precharge relay switch 114) may be used to protect the positive relay switch 120 from high currents when the battery pack 100 is initially connected to the load (e.g., the capacitor 204).

### Example Battery Charging Process

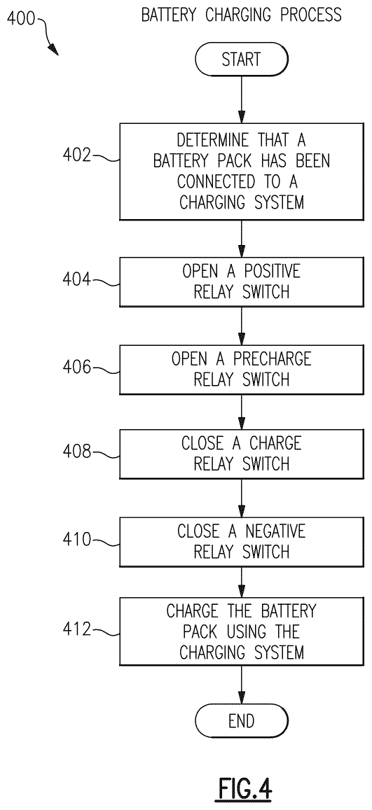

FIG. 4 presents a flowchart of an example battery charging process 400 in accordance with certain embodiments. The battery charging process 400 may be performed in response to a physical or electrical connection being formed between a battery pack 100 (or battery pack circuit 200) and a battery charging system. The battery charging system may be any type of system that can charge a battery pack. In some cases, the battery charging system may be a wall outlet. However, often the battery charging system includes additional circuitry (e.g., an AC-to-DC converter) to facilitate charging a battery pack without damaging the battery pack. The battery charging process 400 may be performed by any device or system that can control operation of a battery pack 100 (or battery pack circuit 200) including, for example, a battery management unit 130. In some cases, one or more operations of battery charging process 400 may be performed automatically or in response to a load being connected to the battery pack 100 (or battery pack circuit 200). In some cases, a handshaking or connection process between the battery pack 100 and the battery charging system may trigger performance of the battery charging process 400.

The battery charging process 400 may begin at the block 402 where it is determined that a battery pack 100 has been connected to a charging system configured to charge a battery (e.g., a battery charging system). The block 402 may include performing a handshaking process to determine that the charging system is connected to the battery pack 100. For example, the battery management unit 130 of the battery pack 100 may perform a handshaking process to determine that the charging system is physically and/or electrically connected a charging port of the battery pack 100. The handshaking process may include any type of process for establishing or confirming that the battery charging system is connected to the battery pack 100 in such a manner that the battery pack 100 can be safely charged by the battery charging system. For example, the handshaking process may include a handshaking process established by the GB/T 27930 protocol, by the Combined Charging System (CCS) standard, by the Charge de Move (CHAdeMO) standard, or by any other electric vehicle battery charging standard or connection handshaking process.

At block 404, the battery charging process 400, using for example the battery management unit 130, involves opening the positive relay switch 120. The battery management unit 130 may control opening or closing any of the relay switches disclosed herein. At block 406, the battery charging process 400 involves opening the precharge relay switch 114. The precharge relay switch 114 may be part of the precharge device circuit 102 and both the precharge relay switch 114 and the positive relay switch 120 may be part of the discharge path of the battery pack 100, or the path where current flows to power a load, such as a motor.

At block 408, the battery charging process 400 involves closing the charge relay switch 124. At block 410, the battery charging process 400 involves closing the negative relay switch 122. By closing the charge relay switch 124 and the negative relay switch 122 a charging path is formed between the battery charging system and the one or more battery modules 110 enabling the battery pack 100 to be charged.

At block 412, the battery charging process 400 involves charging the battery pack 100 using the charging system. In some embodiments, the operations associated with the block 412 occur automatically upon forming the charging path. Alternatively, or in addition, the battery management unit 130 may initiate charging of the one or more battery modules 110. In some cases, the battery charging system may initiate the charging of the one or more battery modules 110.

As with the battery discharge process 300, one or more of the operations of the battery charging process 400 may be performed in a different order, substantially in parallel, or even omitted. For example, in some cases, the block 410 may be omitted because, for example, the negative relay switch 122 may already be closed. As another example, the operations associated with the blocks 404 and 406 may be performed in a different order or in parallel. Further, in some cases, opening or closing the various relay switches may alternatively or additionally include maintaining the various relay switches in a particular state. For example, if the precharge relay switch 114 is already open, the block 406 may include maintaining the precharge relay switch 114 in an open state.

### Example Operating Environment

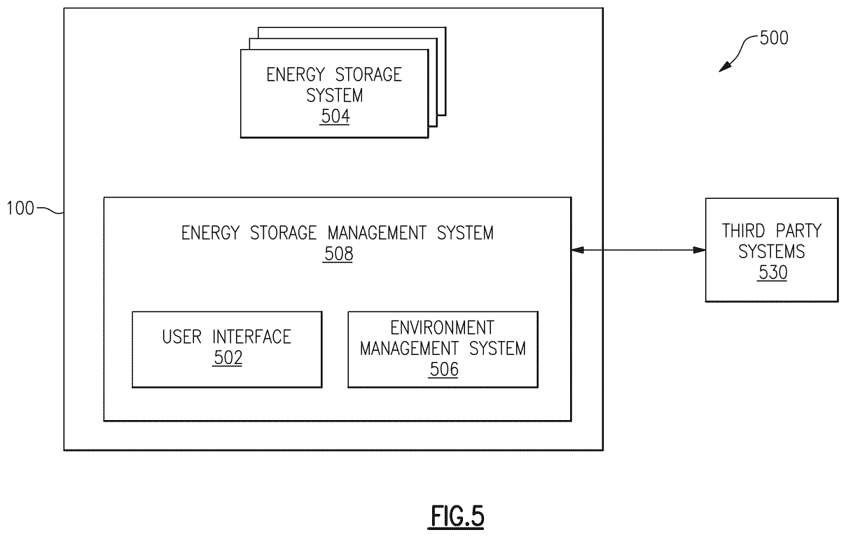

FIG. 5 illustrates an example of an operating environment 500 of a battery pack 100, which may include an energy storage management system 508. Although not all elements are illustrated, the battery pack 100 illustrated in FIG. 5 may include the elements previously described with respect to the prior figures (e.g., FIGS. 1 and 2). The operating environment 500 may include any type of environment that may use a battery pack 100. The operating environment 500 may include any environment where an electric vehicle that is powered by the battery pack 100 may be used. For example, the operating environment 500 may include a warehouse (e.g., a cold storage warehouse or refrigerated warehouse). In other cases, the operating environment 500 may include public or private road networks that may be located in cold weather locations, or elsewhere.

The battery pack 100 may include an energy storage management system 508, which may manage operation of the battery pack 100. In some cases, the energy storage management system 508 may be or may include a battery management system (BMS) or battery management unit 130 configured to manage one or more battery packs. The battery pack 100 may include an energy storage system 504. The energy storage system 504 may be or may include one or more battery modules 110 configured to store charge for powering one or more elements of an electric vehicle (e.g., a motor). Further, in some cases, the energy storage system 504 may include a plurality of energy storage systems.

The energy storage management system 508 may further include a user interface 502 and an environment management system 506, which may also be referred to as a temperature control system. The energy storage management system 508 can communicate with an energy storage system 504 (for example, rechargeable batteries) to, for example, manage charging, discharging, or operating conditions associated with the energy storage system 504. Additionally, in some cases, the energy storage management system 508 can communicate with one or more third-party systems 530 to receive and transmit data therebetween. For example, the one or more third-party systems 530 can include a weather forecasting system that can receive weather-related data. This weather-related data may indicate the likelihood that an ambient temperature is within a particular temperature range. As another non-limiting example, the one or more third-party systems 530 may include an ambient temperature sensor configured to measure a temperature of an ambient environment (e.g., the operating environment 500) external to the energy storage management system 508.

The environment management system 506 may include any system that can manage the ambient temperature within the battery pack 100. The ambient temperature may refer to the temperature in the space within the battery pack 100, which may differ from the temperature of the battery cells or the one or more battery modules 110 themselves. For example, the charging and discharging of the one or more battery modules 110 and/or battery cells may generate heat at least around the terminals of the battery cells. This heat may raise the temperature of the battery cells or one or more battery modules 110 to higher temperature than the ambient environment within the battery pack 100, as well as the ambient environment external to the battery pack 100.

### Example Environment Management System

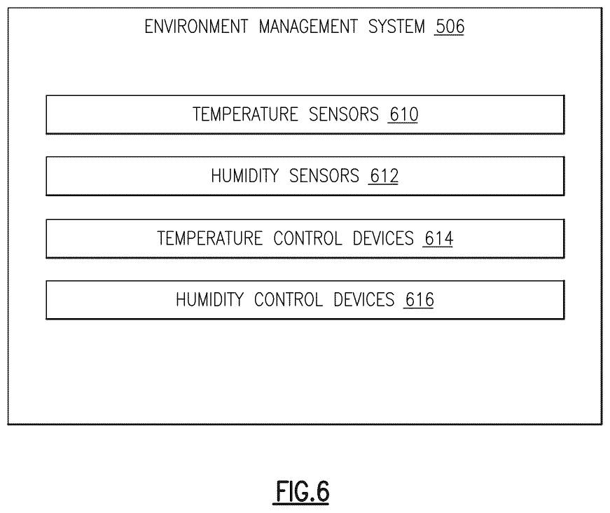

FIG. 6 illustrates a block diagram of environment management system 506 in accordance with certain embodiments. The environment management system 506 can include one or more temperature sensors 610, one or more humidity sensors 612, one or more temperature control devices 614, and one or more humidity control devices 616.

The one or more temperature sensors 610 may include temperature sensors for measuring the ambient temperature within the battery pack 100. In cases where the one or more temperature sensors 610 include a plurality of temperature sensors, the plurality of temperature sensors may be distributed throughout a housing or battery enclosure of the battery pack 100 enabling measurement of the ambient temperature at different points within the battery pack 100. The one or more temperature sensors 610 may be placed at locations within the battery pack 100 such that the measured temperature is that of the ambient environment and not of the one or more battery modules 110 or battery cells themselves that may be higher in temperature than the internal ambient space of the battery pack 100. In some cases, the one or more temperature sensors 610 may include external temperature sensors configured to determine an ambient temperature of an environment external to the battery pack 100.

The one or more temperature control devices 614 may include any type of device that can be used to control or adjust the ambient environment within the battery pack 100. The one or more temperature control devices 614 may include heaters or heating elements. These heating elements may be any type of heating element. In some implementations the heating elements may be positive temperature coefficient (PTC) heaters. The PTC heating elements may include one or more heating discs that can be formed from ceramic materials. The PTC elements can include any type of PTC heating element including, but not limited to, PTC elements based on fin designs and those based on honeycomb designs. In some embodiments, the PTC elements can include a galvanized outer platen, stainless steel corrugated spring, galvanized inner platen, single layer aluminum radiator, double layer aluminum radiator, nickel plated copper electrode terminal, and/or PPS (Phenylene sulfide) high temperature plastic electrode sheath.

In some implementations, the one or more temperature control devices 614 can include heating or resistive traces (for example, carbon conductive inks) that can be applied (for example, printed) on thin, flexible substrates (for example, polymer-based substrates). Substrates that are reliable and efficient for heat transfer may be used. Some suitable materials for the substrate may include, but are not limited to, ceramics (for example, aluminum oxide, aluminum nitride, beryllium oxide, and zirconium oxide), stainless steel (for example, types 304 and 430), aluminum, glass, rubber, or plastics. Substrate material can be chosen based on materials used for conductors (for example, conductive inks printed on the substrate), application condition (or operating environment), operating temperature, power requirements, and cost.

In some implementations, the heating or resistive traces of the one or more temperature control devices 614 can be materials that exhibit positive temperature coefficients. For example, the heating or resistive traces can exhibit a positive resistance change when temperature increases, and a negative resistance change when temperature decreases. As such, the heating or resistive traces having positive temperature coefficients can allow more electrical current to pass in cold environments and can allow less electrical current in hot environments.

In some implementations, the one or more temperature control devices 614 can include a dielectric layer between the substrate and the heating or resistive traces that insulate the heating or resistive traces and reduce the likelihood of (or prevent) current leaks from the heating or resistive traces. The dielectric layer may be optional, such as in cases where non-conductive material is used for the substrate.

Use of PTC heating elements for the one or more temperature control devices 614 may include a number of advantages over other types of heating elements. For example, PTC heating elements may be compact, heat rapidly, and have higher thermal efficiency (e.g., as high as 99%) than many other types of heating elements. Further, PTC heating elements may have a reduced impact to user's health and to the environment because, for example, the lack of glue bonding. Further, PTC heating elements may be durable (e.g., can have a service life of 6,000 hours or more). In addition, PTC heating elements can operate within a wide voltage range (e.g., 12 volts to 380 volts, or more).

The one or more temperature control devices 614 may be attached or affixed to an inner side of the battery enclosure that houses the elements of the battery pack 100. The one or more temperature control devices 614 may be affixed to the battery enclosure using an insulative layer and/or a thermal conductive silica gel (or any other type of thermal conductive gel) that increase thermal conductivity. Further, the one or more temperature control devices 614 may be attached to a side or top location of the battery enclosure and at a point that warms the ambient environment of the battery pack 100 without warming or while minimally warming the one or more battery modules 110 or battery cells themselves. In other cases, the one or more temperature control devices 614 may be configured to warm both the ambient environment and the one or more battery modules 110.

In some cases, an isolation protrusion bar or an insulator may be used to separate the heating element from the inner surface of the battery enclosure to prevent, for example, conduction between the heating element and the battery enclosure. Thus, while the heating element may be affixed to the inner surface of the battery enclosure, an isolation layer of insulator may separate the heating element from direct contact with the battery enclosure. The environment management system 506 may include additional components that facilitate connection and control of the one or more temperature control devices 614. For example, the environment management system 506 may include a power connector and battery management module that supply power to the one or more temperature control devices 614 and manage operation of the one or more temperature control devices 614, respectively.

In addition to the one or more temperature sensors 610 and the one or more temperature control devices 614, the environment management system 506 may include other environment control systems. For example, as stated above, the environment management system 506 may include one or more humidity sensors 612 and one or more humidity control devices 616. The one or more humidity sensors 612 may include any type of sensors that can measure the humidity level with a battery enclosure of the battery pack 100. For example, the one or more humidity sensors 612 may include capacitive, resistive, or thermal humidity sensors.

The one or more humidity control devices 616 can include any type of device that can control or maintain the humidity within the battery enclosure of the battery pack 100 at a particular level or within a particular range. It can be important to control humidity within the battery pack 100 to avoid short circuits and to save energy. The one or more humidity control devices 616 can include humidity control sheets or desiccants. In some cases, the desiccants can be regenerated periodically or upon detection of rising humidity levels by using the one or more temperature control devices 614. Alternatively, or in addition, the one or more humidity control devices 616 can include the one or more temperature control devices 614 and may use the one or more temperature control devices 614 to maintain the ambient temperature within the battery enclosure at a temperature that reduces humidity.

In some cases, humidity is controlled by the one or more temperature control devices 614. In some such cases, the one or more humidity control devices 616 may be optional or omitted as, for example, the one or more temperature control devices 614 may serve as the humidity control devices. Further, in some cases, the one or more humidity sensors 612 may be optional or omitted. For example, environment management system 506 (or the battery management unit 130) may maintain an ambient temperature within the battery pack 100 using the one or more temperature sensors 610 and the one or more temperature control devices 614. Maintaining the ambient temperature may include maintaining the ambient temperature within a temperature range that reduces or prevents humidity from damaging the one or more battery modules 110 and/or the battery pack 100. For example, the ambient temperature may be maintained with 5 to 15 degrees Celsius, which may prevent humidity damage due to condensation of water within the air of the ambient environment internal to the battery pack 100.

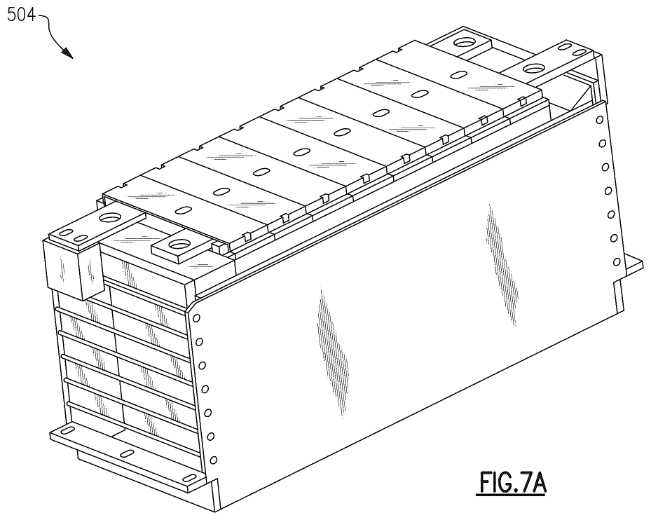

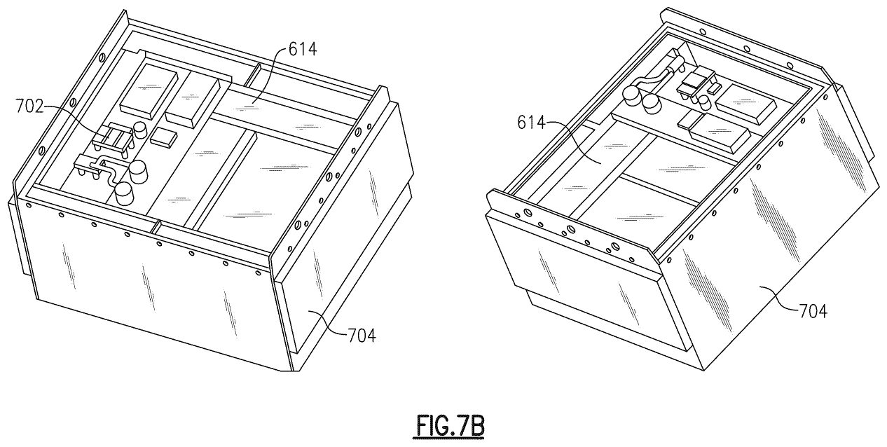

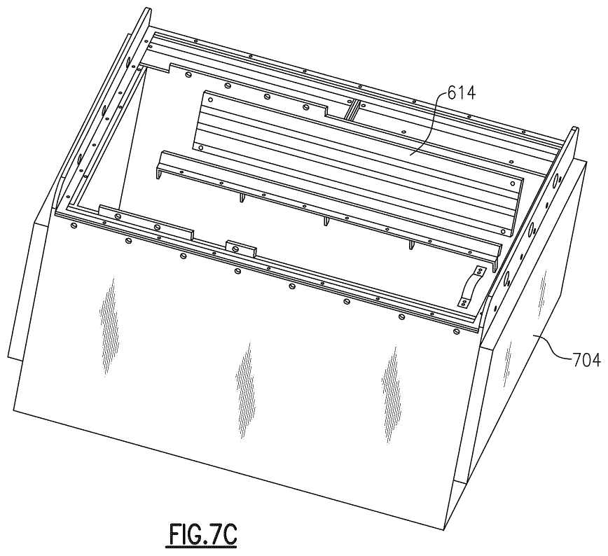

FIG. 7A illustrates an example embodiment of the energy storage system 504. The upper cover of the energy storage system 504 can include a control board (e.g., a printed circuit board), which can include a DC-DC converter, a relay, and a fuse. Further, the energy storage system 504 may include a maintenance cover to facilitate maintenance of the energy storage system 504. In some implementations, thermal conductive silica gel is installed under each battery module for insulation and thermal conductivity.

The one or more temperature control devices 614 described herein can fit inside a battery enclosure, which can house one or more battery modules 110, the precharge device circuit 102, and the energy storage management system 508, among other elements. Further, the battery enclosure may house one or more insulation elements between the PTC heating elements and the inner surface of the battery enclosure. The arrangement of the one or more insulation elements may provide for more uniform heat conduction, high heat transfer efficiency, good insulation performance, and high electric gas safety.

In some cases, the battery pack 100 may include at least two temperature sensors 610. In such cases, the plurality of temperature sensors 610 may be located at different positions within the battery enclosure of the battery pack 100 enabling measurement of the ambient temperature at multiple locations within the battery pack 100. Advantageously, measuring the ambient temperature at different locations enables a more accurate temperature measurement than measuring the temperature at a single location.

FIG. 7B illustrates example locations of the one or more temperature control devices 614 may be installed within the battery pack 100. Additional circuit elements for controlling the one or more temperature control devices 614 may be positioned on a PCB 702 (e.g., a heating fuse, a relay, a controller and/or a battery management system) that provides current to the one or more temperature control devices 614 to activate the one or more temperature control devices 614.

The one or more temperature control devices 614 can be wired to one or more battery modules 110 stored inside the battery pack 100 to draw energy when it is determined that the ambient temperature of the battery pack 100 is below a threshold. Further, the one or more temperature control devices 614 may be located on the sides of the battery enclosure 704 at positions that are at least a threshold distance away from the battery cells and/or the one or more battery modules 110. Being positioned away from the battery cells may include being positioned away from the terminals of the one or more battery modules 110.

FIG. 7C illustrates attachment of an example temperature control device 614 within a battery enclosure 704 of a battery pack 100 in accordance with certain embodiments. In some implementations a temperature control device 614 may be affixed to an inner surface of the battery enclosure 704 using any type of attachment mechanism including screws, tape, glue, clips, etc. Further, a second temperature control device 614 (not illustrated) may be affixed to an inner surface on an opposite side from the illustrated temperature control device 614. In some cases, additional temperature control devices 614 may be positioned throughout the battery enclosure 704 and at positions that can regulate the temperature of the open space within the battery enclosure 704 while not heating or having a minimum impact on a heat of the one or more battery modules 110. In some implementations, the one or more temperature control devices 614 may be positioned at an upper portion of the battery enclosure 704, or at any location that will enable controlling the temperature of open space within the battery enclosure 704. Generally, the one or more temperature control devices 614 are not positioned at locations that may heat the one or more battery modules 110, such as under the one or more battery modules 110 or on top of the terminals of the one or more battery modules 110. Although, in some cases, some of the heat generated by the one or more temperature control devices 614 may affect the temperature of the one or more battery modules 110 due to proximity or electrical connections, generally the one or more temperature control devices 614 are configured to primarily heat the open space within the battery enclosure 704. For example, a majority of the heat emitted by the one or more temperature control devices 614 may be directed towards the open space of the battery enclosure 704. In some cases, 75%, 80%, 90%, 95%, 99%, or more, or percentages in between of the heat emitted by the one or more temperature control devices 614 may be directed towards heating the open space of the battery enclosure 704.

The one or more temperature sensors 610 may be positioned at the same location as the one or more temperature control devices 614. Alternatively, the one or more temperature sensors 610 may be positioned away from the one or more temperature control devices 614. For example, the one or more temperature sensors 610 may be positioned on the sides of the battery enclosure 704 where the one or more temperature control devices 614 are not located.

The size and the number of temperature control devices 614 may be selected based at least in part on a size of the battery enclosure 704 or of the battery pack 100, a size of the open space within the battery enclosure 704, an amount of heat generated by one or more battery modules 110 of the battery pack 100, or any other factor that may impact an amount of humidity and a temperature within the battery enclosure 704.

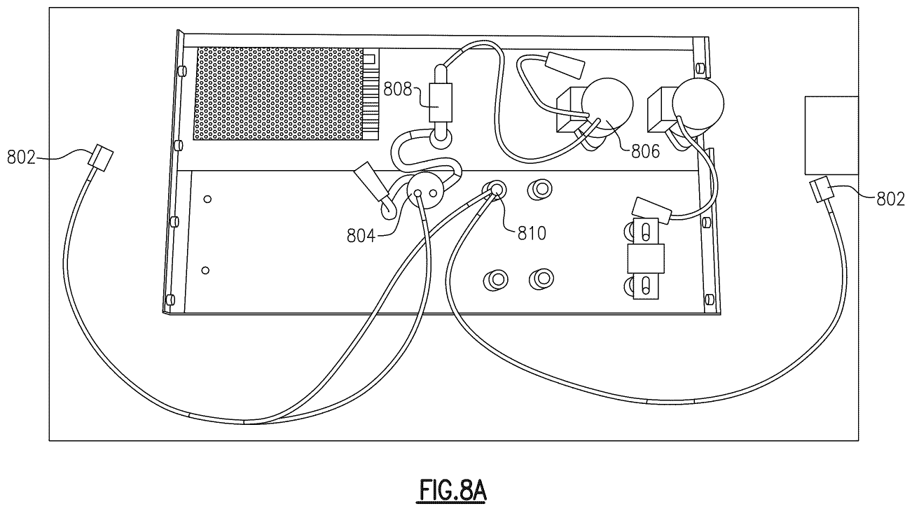

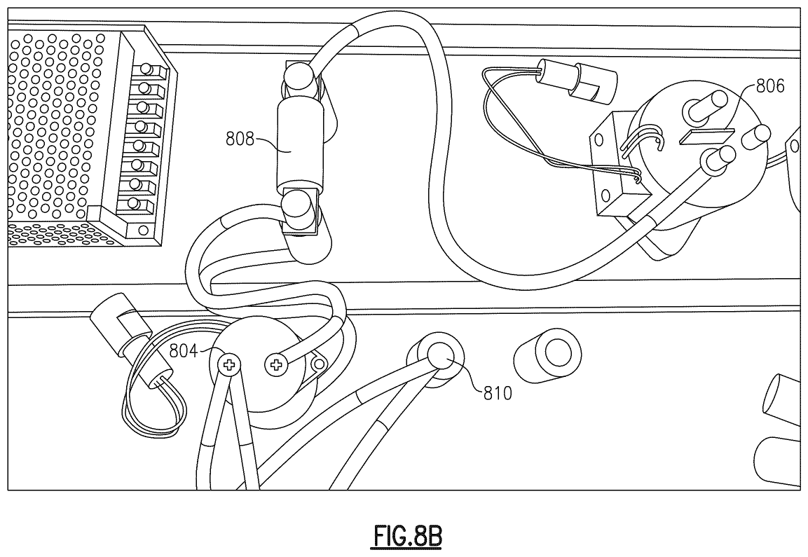

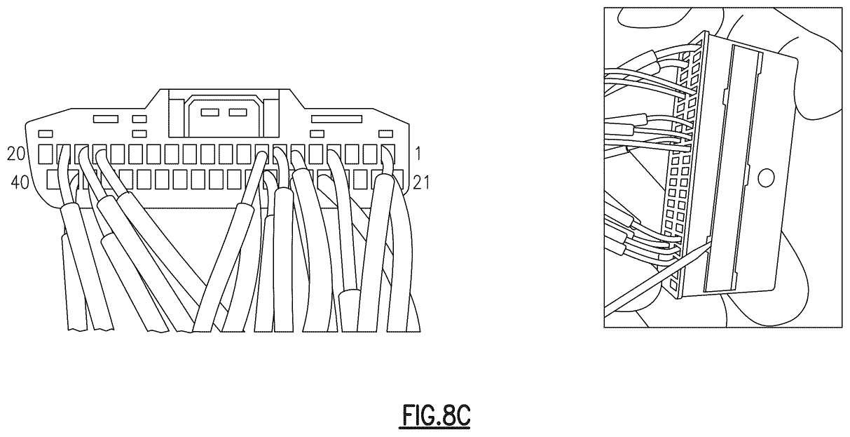

FIG. 8A and FIG. 8B illustrate example wiring for the temperature control device 614. As illustrated in FIG. 8A and FIG. 8B, the one or more temperature control devices 614 can be connected to the one or more battery modules 110 via connectors 802, which are connected to a discharge relay 806, a heating fuse 808, and a heating relay 804. Additionally, the temperature control device 614 can be connected to a current diverter 810 of the battery pack. The current diverter 810 can provide a low impedance path to an electrical ground to protect against shaft currents that may be generated by, for example, a motor of the electric vehicle that is connected to the battery pack 100.

FIG. 8C illustrates an example wiring harness 820 for connecting the one or more temperature control devices 614 to the battery management unit 130. The wiring harness 820 can, for example, be connected to and receive signals from the energy storage management system 508 (for example, a battery management unit 130). As such, the energy storage management system 508 can control the one or more temperature control devices 614.

### Example Temperature Control Device

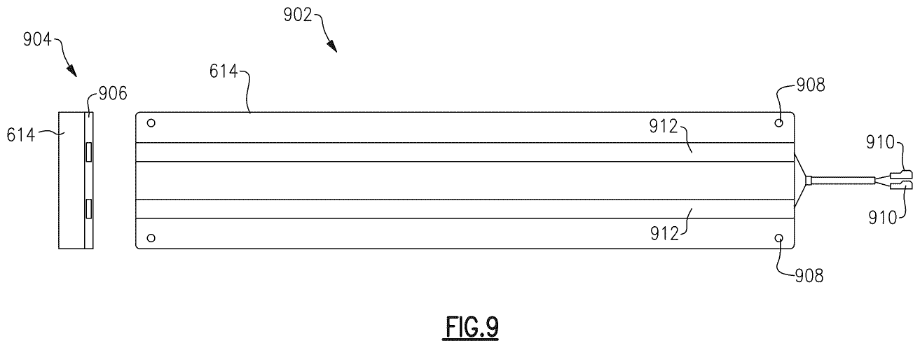

FIG. 9 illustrates an example of the one or more temperature control devices 614 (for example, a PTC heating plate) that can be mounted within a battery enclosure of the battery pack 100. FIG. 9 illustrates a top view 902 and a side view 904 of the one or more temperature control devices 614. As illustrated by the side view 904, the one or more temperature control devices 614 may include a thermal conductive silica gel pad 906 on a bottom of the one or more temperature control devices 614 that separates the one or more temperature control devices 614 from a surface of the battery pack 100 to which the one or more temperature control devices 614 is affixed. In some implementations, a layer of the thermal conductive silica gel pad 906 may be positioned on both a top and bottom of the one or more temperature control devices 614. In some cases, the one or more temperature control devices 614 may include one or more apertures 908 that can be used to attach (fixedly or removably) the temperature control device one or more temperature control devices 614 to a battery pack 100.

Further, the one or more temperature control devices 614 may include one or more connectors 910 configured to connect to the connectors 802 of the battery pack 100. These connectors 802 may connect the one or more temperature control devices 614 to the one or more battery modules 110 so that the one or more battery modules 110 may power the one or more temperature control devices 614. Alternatively, the connectors 802 may connect the one or more temperature control devices 614, via the one or more connectors 910, to the battery management unit 130 (which may also be termed a battery management system) or the energy storage management system 508 (which may be the battery management unit 130). The battery management unit 130 and/or the energy storage management system 508 may control whether and/or when the one or more temperature control devices 614 are active.

The one or more connectors 910 may connect to one or more electrical traces 912 on the one or more temperature control devices 614. Current may be supplied by the one or more battery modules 110, the battery management unit 130, and/or the energy storage management system 508 to the one or more connectors 910, which may supply the current to the one or more electrical traces 912. The applied current to the one or more electrical traces 912 may cause heat to be generated by the one or more temperature control devices 614, which may heat the ambient environment within the space of the battery pack 100 that surrounds the one or more battery modules 110.

### Example User Interface

In some implementations, the energy storage management system 508 described herein can include or can communicate with a display that can illustrate status information of the battery pack 100. In some embodiments, the display is integrated with the battery pack 100. In some such cases, the user interface 502 may include the display. Further, the user interface 502 may include user interface elements that enable a user to interact with the battery pack 100. The user interface 502 may include a touchscreen display or any other type of display that can present information to a user and/or receive user input. In some cases, the display is located at a separate electronic device. In such cases, the battery pack 100 may communicate with the separate electronic device via a wired or wireless connection.

The display can allow users to monitor and/or control various parameters of the battery pack 100 including, but not limited to, individual battery cell voltages, average battery cell voltages, max cell voltages, minimum cell voltages, average cell temperature, maximum cell temperature, minimum cell temperature, charge relay status, discharge relay status, DC/DC relay status, heating relay status, ambient temperature within the battery pack 100, humidity measurements within the battery pack 100, external temperature measurements, and the like.

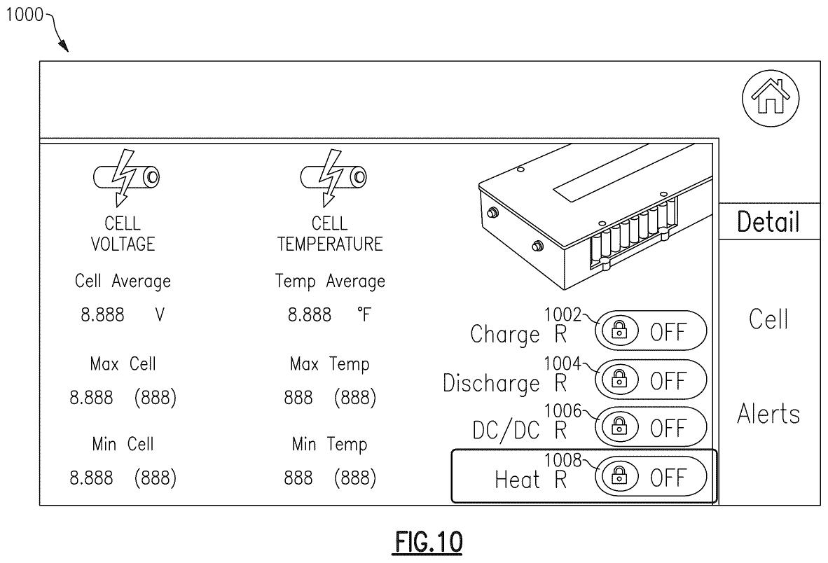

FIG. 10 illustrates an example user interface screen 1000 that can be displayed by the user interface 502 (e.g., a display). In some implementations, the user interface 502 may include user interface elements that enable a user to interact with the user interface screen 1000. For example, the user interface screen 1000 may include a charge toggle 1002, a discharge toggle 1004, a DC-DC toggle 1006, and a heating toggle 1008. The charge toggle 1002 may be used to control whether the battery pack 100 is to recharge the one or more battery modules 110. When the charge toggle 1002 is moved to the on position, the battery management unit 130 may trigger a charging process, such as the battery charging process 400. In some cases, the toggling of the charge toggle 1002 may cause the charge relay switch 124 to close. In some cases, the charge toggle 1002 may be locked or otherwise inaccessible if the battery management unit 130 determines that a connection to a battery charging system has not been established. In some cases, the battery management unit 130 controls the charging process, but interacting with the charge toggle 1002 may indicate to the battery management unit 130 whether the charging process is available or permitted.

The discharge toggle 1004 may be used to control whether the battery pack 100 is being used to power a connected device (e.g., a motor of an electric vehicle). When the discharge toggle 1004 is moved to the on position, the battery management unit 130 may trigger a discharge process, such as the battery discharge process 300. In some cases, the toggling of the discharge toggle 1004 may cause the precharge device circuit 102 to close the precharge relay switch 114. In some cases, the discharge toggle 1004 may be locked or otherwise inaccessible if the battery management unit 130 determines that a connection to a load (e.g., a motor) to be powered by the battery pack 100 has not been established. In some cases, the battery management unit 130 controls the discharging process, but interacting with the discharge toggle 1004 may indicate to the battery management unit 130 whether the discharging process is available or permitted.

The DC-DC toggle 1006 may cause the DC-DC circuit to modify a DC voltage level of a voltage output by the one or more battery modules 110. In some cases, the DC-DC circuit may be activated as part of the discharge process. In some cases, the battery management unit 130 controls the DC-DC conversion process, but interacting with the DC-DC toggle 1006 may indicate to the battery management unit 130 whether the DC-DC conversion is available for use.

The heating toggle 1008 may enable the one or more temperature control devices 614. Once enabled, the battery management unit 130 may control whether the one or more temperature control devices 614 are active or not based at least in part on a determined ambient temperature inside a battery enclosure of the battery pack 100. In some cases, the one or more temperature control devices 614 may be active when the heating toggle 1008 is toggled, but the battery management unit 130 may control the amount of heating.

In some embodiments, the charge toggle 1002, discharge toggle 1004, DC-DC toggle 1006, and/or heating toggle 1008 are informational and are not modifiable by a user. In other words, the charge toggle 1002, discharge toggle 1004, DC-DC toggle 1006, and/or heating toggle 1008 may indicate, respectively, whether charging, discharging, DC-DC conversion, or ambient heating are active, but may not be controlled by a user. In some implementations, each of the charge toggle 1002, discharge toggle 1004, DC-DC toggle 1006, and/or heating toggle 1008 may activate one or more switches or relays corresponding to the associated functionality enabling the functionality within the battery pack 100.

In some implementations, a user, using the user interface screen 1000, can configure alerts based at least in part on a cell voltage, a cell temperature, and/or various relay statuses. Further, the user may be able to view existing alerts generated based at least in part on cell voltage, cell temperature, and/or various relay statuses. In some implementations, the user may view parameters associated with individual cells in a battery pack 100, groups of cells, or one or more battery modules 110.

As described herein, the environment management system 506 can be programmed to operate (for example, turn on) the one or more temperature control devices 614 (for example, PTC heating plates) when it is determined that an ambient temperature within a battery enclosure or housing of the battery pack 100 is less than a threshold temperature (for example, 68° F., 15° C., 25° C., etc.) or within a temperature range (for example, between 40° F. and 68° F., 5 to 15° C., 20 to 35° C., etc.). The threshold temperature or the temperature range can be user configurable (or adjustable). In some embodiments, as described herein, the energy storage management system 508 can receive weather data from, for example, the one or more third-party systems 530. This weather data may be used to adjust or set the threshold temperature or the temperature range.

The threshold temperature can vary depending on one or more factors. For example, when operating in cold environments (for example, less than 10 or 5° C., such as cold storage refrigerators), battery modules 110 can discharge faster than when operated in warm environments (for example, above 20 or 25° C.). In some cases, the temperature of the one or more battery modules 110 themselves or the terminals of the one or more battery modules 110 may be higher than the temperature of the ambient environment within the battery pack 100. Thus, measuring temperature of the one or more battery modules 110 or the terminals of the one or more battery modules 110 may not result in activation of the one or more temperature control devices 614. By positioning the one or more temperature sensors 610 to measure the temperature of the ambient environment in addition to or instead of the one or more battery modules 110 (or terminals thereof) enables the one or more temperature control devices 614 to be activated when the ambient temperature drops below the threshold temperature or below the target temperature range. The target temperature range may be any temperature range that reduces harm due to cold temperatures and/or humidity. For example, the target temperature range may be between 20 and 35 degrees Celsius, between 10 and 20 degrees Celsius, between 5 and 15 degrees Celsius, or any other temperature range. Further, the temperature range may vary based on operating environment and/or the size of the battery enclosure or the amount of open space within the battery enclosure.

Further, humidity can cause damage to a battery pack. Maintaining the ambient temperature of the space within the battery enclosure of the battery pack 100 at a particular temperature or within a particular temperature range can reduce or prevent the buildup of humidity within the battery enclosure. In some cases, activating a heating element when an ambient temperature is below a particular temperature may cause moisture within the air condensate on the battery cells, which may cause damage to the battery pack 100. Accordingly, in some cases, the one or more temperature control devices 614 may be activated when a temperature within the battery enclosure of the battery pack 100 is within a particular temperature range, and not activated when the ambient temperature is below a minimum value of the temperature range.

In some implementations, the energy storage management system 508 (for example, a battery management unit 130 or battery management system) can include an environmental probe interface that enables a user to use an environment probe in addition to, or as an alternative to, the one or more temperature sensors 610 and/or one or more humidity sensors 612. Environment probes may be used to detect a level of humidity inside the battery pack 100 or a temperature within ambient environment of the battery pack 100.

In some implementations, the battery management unit 130 can transmit or make available status and/or configuration data for the battery pack 100. This data may be transmitted via a wired or wireless network connection. Alternatively, the data may be stored in a memory or register of the battery management unit 130 and may be accessed by plugging an external computing device (e.g., a code scanner) into a status port (e.g., a universal serial bus port) of the battery management unit 130

TABLE 1
Example Battery Management System Message Configuration

| Message name: | BMS Data | | | | ID: | 0X2F0 | Period | 50 ms |
|---|---|---|---|---|---|---|---|---|
| 1, 2 Byte | Total voltage, Offset 0, in 0.1 V | | | | | | | |
| 3, 4 Byte | Total current, Offset - 300 A, unit: 0.1 A | | | | | | | |
| 5 Byte | SOC, Offset 0, unit 0.4% | | | | | | | |
| 6 Byte | Capacity, Offset 0, unit 2 Ah | | | | | | | |
| | State | | Over | | Unit | | | |
| | of | Temperature | temperature | Over | under | Communication | Cell over | Total |
| | charge | protection | protection | current | voltage | interruption | discharge | Voltage |
| 7 Byte | Bit 8 | Bit 7 | Bit 6 | Bit 5 | Bit 4 | Bit 3 | Bit 2 | Bit 1 |

| | |
|---|---|
| 8 Byte | 0 Reserved |

Table 1 illustrates an example message configuration the status and/or configuration data that may be generated by the battery management unit 130. The configuration data may be associated with a battery pack 100 and/or one or more battery cells of the battery pack 100. The configuration data may include, but is not limited to, total voltage, total current, state of charge (SOC), capacity, and the like. In the example, illustrated in Table 1, the battery management unit 130 can use 8 binary bits to provide status information for the battery pack 100. The “Temperature protection” bit (for example, bit 7) can be indicative of low temperature (for example, temperature of the ambient environment within the battery pack 100 is too low), the “Over temperature protection” bit (for example, bit 6) can be indicative of high temperature (for example, temperature of the ambient environment within the battery pack 100 is too high), the “Unit undervoltage” bit (for example, bit 4) can be indicative of an alarm value (for example, a temperature set point such that when the temperature of the ambient environment within the battery pack 100 is below the set point or target threshold, an alarm is generated), the “Cell over discharge” bit (for example, bit 2) can be indicative of protection value, the “Total voltage” bit (for example, bit 1) can be indicative of when the total voltage of, for example, the battery pack 100 or a battery cell, is too high or exceeds a threshold. The “Charge state” bit (for example, bit 1) can be indicative of whether the battery pack 100 or a battery cell is being charged or discharged. For example, the “Charge state” bit can be 0 when the battery pack 100 is being charged, 1 when the battery pack 100 is being discharged. The “Over current” bit (for example, bit 5) can be indicative of when the current associated with charge or discharge is above a predetermined threshold. The “Communication interruption” bit (for example, bit 3) can be indicative of any communication-related issues (for example, unable to establish a communication link with another device) associated with the battery management unit 130.

The one or more temperature control devices 614 may function as humidity control devices. In some cases, in addition to the one or more temperature control devices 614, one or more additional humidity control devices 616 may be installed inside the battery pack 100. The one or more humidity control devices 616 may include humidity control sheets, additional heater elements, or may include the one or more temperature control devices 614. Depending on the space available and the dimensions of the battery pack 100, one or more one or more humidity control devices 616 of different sizes can be used. By controlling (for example, reducing) the humidity level inside a battery enclosure of the battery pack 100, corrosions of various battery parts (for example, copper leads) can be prevented (or reduced). The one or more humidity control devices 616 may prevent repel or absorb moisture to control humidity around batteries in the battery pack 100.

### Example Ambient Temperature Modification Process

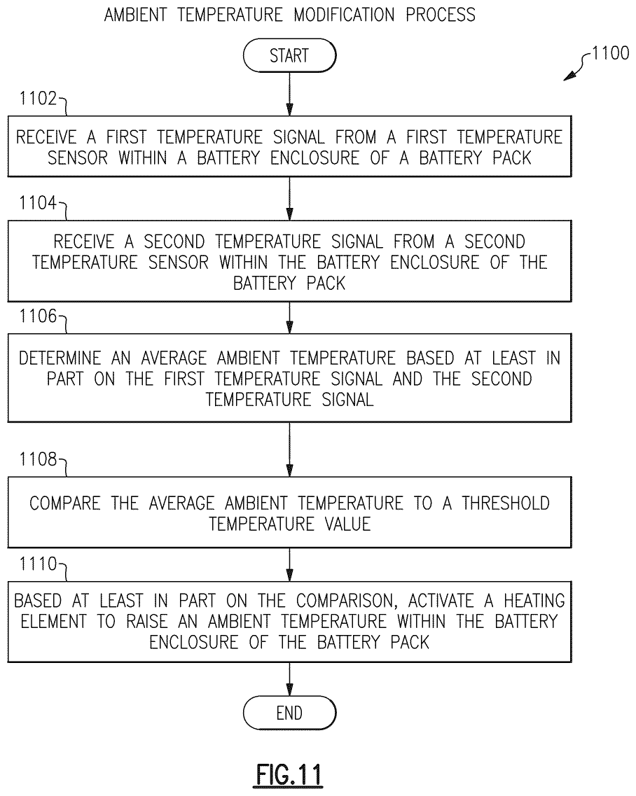

FIG. 11 illustrates an example ambient temperature modification process 1100 in accordance with certain embodiments. The ambient temperature modification process 1100 may be performed to maintain an ambient temperature within a battery enclosure 704 of a battery pack 100. Maintaining the ambient temperature within the battery enclosure 704 can help reduce or eliminate damage that may occur from humidity within the battery pack 100, when the battery pack 100 is operated in a cold environment (e.g., cold storage warehouse). The ambient temperature modification process 1100 may be performed by any system that can maintain the ambient temperature or temperature of an environment inside of a battery enclosure of the battery pack 100. For example, the ambient temperature modification process 1100 may be performed by a controller, a battery management unit 130, one or more temperature sensors 610, one or more temperature control devices 614, and the like. The ambient temperature modification process 1100 may be performed continuously, in response to a command, when the battery pack 100 is performing a discharging process (e.g., is in use to power a system, such as a motor), when the battery pack 100 is performing a charging process, when an external temperature is below a particular threshold, or in response to any other type of trigger that may cause the battery management unit 130 to determine and/or maintain an ambient temperature of an internal cavity of the battery pack 100.

The process 1100 may begin at the block 1102 where, for example, the battery management unit 130 receives a first temperature signal from a first temperature sensor (e.g., a temperature sensor 610) within a battery enclosure 704 of a battery pack 100. The first temperature signal may correspond to an ambient temperature measured at a first location within the battery enclosure 704. The ambient temperature may refer to the temperature of an internal cavity or open space within the battery pack 100. In some cases, the ambient temperature may be distinct from a temperature of one or more elements within the battery pack 100, such as the one or more battery modules 110, battery cells, or terminals of the battery cells. In some cases, the first temperature signal may be an aggregate or average of a plurality of temperature signals corresponding to a plurality of temperature readings taken within a particular time period (e.g., every 5 seconds over a minute time period, or every second over a 5 second time period, etc.).

At the block 1104, the battery management unit 130 receives a second temperature signal from a second temperature sensor within the battery enclosure 704 of the battery pack 100. The second temperature sensor may be located at a different location within the battery enclosure 704. The second temperature signal may correspond to an ambient temperature measured at a second location. The measurement locations of the ambient temperature may be on opposite sides of the battery enclosure 704. Each of the temperature sensors 610 may be positioned to measure the ambient temperature within the battery enclosure 704 at different locations of the battery enclosure 704 without measuring a temperature of the one or more battery modules 110 or the battery cells of the battery pack 100. In some cases, the temperature of the battery cells may have an impact on the ambient temperature, but the one or more temperature sensors 610 may be positioned at a location that minimizes the impact of the temperature of the battery cells on the ambient temperature. In some cases, the temperature sensors 610 may be at least a minimum distance away from the plurality of battery cells of the battery pack 100. Further, in some cases, the distance of the first temperature sensor and the second temperature sensor may be the same or a different distance away from the battery cells. Similarly, the one or more temperature control devices 614 may be located a minimum distance away from the battery cells. Further, when the battery pack 100 includes multiple temperature control devices 614, at least two of the temperature control devices may be positioned equidistant from the battery cells. Alternatively, the temperature control devices may be different distances from the battery cells, but at least a minimum distance away. In some cases, the one or more temperature control devices 614 are positioned a minimum distance away from the one or more temperature sensors 610.

As with the first temperature signal, the second temperature signal may be an aggregate or average of a plurality of temperature signals corresponding to a plurality of temperature readings taken within a particular time period by the second temperature sensor. The particular time period may be the same for both the block 1102 and the block 1104.

At the block 1106, the battery management unit 130 determines an average ambient temperature of the battery enclosure 704 or the space within the battery enclosure 704. The average ambient temperature may be based at least in part on the first temperature signal obtained at the block 1102 and the second temperature signal obtained at the block 1104. In some cases, the average ambient temperature may be determined by averaging temperature signals from more than two temperature sensors 610. Further, the block 1106 may include averaging temperature values corresponding to the temperature signals rather than the temperature signals themselves. In some cases, the average ambient temperature calculated at the block 1106 may be an average of several average temperatures or aggregate temperatures. For example, as described with respect to the blocks 1102 and 1104, the temperature signals obtained at the blocks 1102 and 1104 may be aggregates or averages of temperatures measured over a time period. In some such cases, the block 1106 may include average the average or aggregate temperatures obtained at the blocks 1102 and 1104.

In some cases, the block 1106 may include weighting some of the temperature values. For example, an ambient temperature that is measured by a temperature sensor 610 positioned at a more central location may be weighted more heavily than an ambient temperature that is measured by a temperature sensor positioned at a less central position or positioned nearer to the battery cells. In some cases, the blocks 1102, 1104, and 1106 may include converting one or more temperature signals generated by the one or more temperature sensors 610 into one or more values corresponding to measured temperatures.

At the block 1108, the battery management unit 130 compares the average ambient temperature to a threshold temperature value. In some cases, the block 1108 may include determining whether the average ambient temperature value is within a target temperature range, is below a minimum threshold temperature, or is above a maximum threshold temperature.

At block 1110, the battery management unit 130, based at least in part on the comparison result of the comparison performed at the block 1108, activates a heating element (e.g., a temperature control device 614) to raise the ambient temperature within the battery enclosure of the battery pack 100. Activating the heating element may include activating a plurality of heating elements (e.g., a plurality of temperature control devices 614, such as PTC heaters). If the ambient temperature determined at the block 1108 is within a target or desired temperature range (or is above a minimum temperature), the battery management unit 130 may not activate the heating element. In some cases, the heating element may be active or inactive. Additionally, or alternatively, the heating element may be adjusted to generate different wattage or joule values based at least in part on a difference between the ambient temperature and the target temperature value or range. In some cases, if the ambient temperature is lower than a minimum threshold value or higher than a maximum threshold value, the heating element may not be activated. By not activating the heating element when the ambient temperature is lower than a minimum value, the potential harm from humidity caused by the warm air coming in contact with the cold surfaces of the battery enclosure 704 are reduced or eliminated.

In some embodiments, the battery management unit 130 may adjust or control one or more humidity control devices 616 based at least in part on the temperature values determined at the block 1102 and the block 1104. Further, the process 1100 may include measuring a humidity level within the battery pack 100. The battery management unit 130 may control the one or more humidity control devices 616 based at least in part on the measured humidity level separately or in addition to using the one or more temperature control devices 614 to control humidity.

Further, in some cases, an external or ambient temperature of an operating environment may be determined using one or more external temperature sensors that are external to the battery pack 100. In some such cases, the battery management unit 130 may activate the one or more temperature control devices 614 based at least in part on the external ambient temperature and/or a trend in the external temperature. For example, if the external ambient temperature is reducing over time, the battery management unit 130 may heat or preheat the internal environment of the battery pack 100 during or prior to use. Further, in some cases, the target temperature range and/or a threshold temperature for activating or deactivating the one or more temperature control devices 614 may be set based at least in part on the external temperature. By adjusting the target temperature range and/or threshold temperatures based on the external temperature, it is possible to reduce the harm from humidity within the battery enclosure 704 and the possibility of condensation from occurring within the battery enclosure 704. In some cases, the battery management unit 130 may activate one or more temperature control devices 614 based at least in part on a determination of whether the external ambient temperature satisfies an ambient threshold temperature value.

In some cases, the process 1100 may continue to be performed, or may be performed on a scheduled basis. In some such cases, the battery management unit 130 may determine to deactivate or reduce an amount of heat generated by the one or more temperature control devices 614 based at least in part on temperature values obtained during a further iteration of the process 1100 (e.g., at the block 1102 and the block 1104 during a second iteration of the process 1100). If it is determined that the additional temperature values (or the average ambient temperature determined at the block 1106 during the second iteration of the process 1100) are within the target temperature range or are not lower than a minimum threshold temperature, then the battery management unit 130 may deactivate the one or more temperature control devices 614 or reduce the heat generated by the one or more temperature control devices 614.

### Example Dual Use of Precharge Device Circuit

As noted above with respect to FIG. 1 and FIG. 2, the precharge device circuit 102 can prevent damage to precharge relay switch 114 and a load (e.g., a motor) caused by instantaneous high voltage and high current of the battery pack 100. For example, the inclusion of the resistance 116 can protect both the precharge relay switch 114 and the load from damage that may be caused by the immediate or instantaneous high voltage and/or high current of the battery pack 100 when the battery pack 100 is connected to the load.

In some examples, the precharge device circuit 102 of FIG. 1 and FIG. 2 may additionally and optionally control temperature and/or humidity associated with the battery pack 100 and the battery pack circuit 200. For example, the precharge device circuit 102 may use the resistance 116 to generate heat for regulating temperature and humidity within the battery pack 100. When the precharge device circuit 102 closes the relay switch 114, current flows through the resistance 116, generating heat. This heat can be used to raise the ambient temperature within the battery pack 100, thereby at least improving the performance of the battery cells in cold environments. Additionally, the generated heat can help reduce humidity levels within the battery pack 100, preventing condensation and/or corrosion of battery components. By controlling the operation of the precharge relay switch 114 to use the resistance 116 to generate heat, the precharge device circuit 102 can provide both electrical protection (e.g., preventing damage caused by instantaneous high voltage and high current) and environmental conditioning (e.g., regulating temperature and humidity to avoid condensation that may be particularly prone to occur under sudden or greater temperature fluctuation) for the battery pack 100.

In some examples, the precharge device circuit 102 may control, based on dynamic calculation of a dew point, the precharge relay switch 114 to use the resistance 116 for generating heat. For example, the precharge device circuit 102 can close the precharge relay switch 114 to use the resistance 116 to generate heat when the dew point is reached. The dew point may be calculated dynamically based on the temperature (e.g., ambient temperature within the battery pack 100) and humidity (e.g., humidity within the battery pack 100). Additionally, and optionally, the dew point may be calculated based on an altitude of the battery pack 100.

As may be appreciated, the dew point may be the temperature at which air becomes saturated with moisture and condensation begins to form. By sensing at least the temperature (e.g., using one or more temperature sensors 610) and humidity (e.g., using one or more humidity sensors 612) within the battery pack 100, the environment management system 506 can dynamically calculate the dew point (e.g., using certain mathematical formulations that taken the humidity and the temperature into consideration for calculating the dew point). Based on the calculated dew point, the precharge device circuit 102 can control the precharge relay switch 114 to use the resistance 116 for generating heat to regulate temperature and humidity within the battery pack 100. For example, when the ambient temperature within the battery pack 100 reaches the calculated dew point, the precharge device circuit 102 may close the precharge relay switch 114, allowing current to flow through the resistance 116 to generate heat. This heat raises the ambient temperature within the battery pack 100, preventing condensation from forming and thereby protecting the battery components from moisture-related damage.

In some examples, based on the calculated dew point, the precharge device circuit 102 may close the precharge relay switch 114 to cause the resistance 116 to generate heat when relative humidity is between 20% to 60%, between 25% to 55%, between 30% to 50%, between 35% to 45%, between 37% to 43%, or any range of values therebetween. By closing the precharge relay switch 114 to cause the resistance 116 to generate heat under relative humidity mentioned above, the battery pack 100 may more likely prevent occurrence of condensation compared with situations where heating elements are activated under higher relative humidity (e.g., 90%, 95%, or the like).

Using the resistance 116 to generate heat besides precharging offers at least several advantages. For example, heat generated by the resistance 116 may be repurposed reducing or eliminating waste, thereby improving energy efficiency. Instead of dissipating the heat generated by the resistance 116 as a byproduct, the heat generated by the resistance 116 is utilized to achieve better (e.g., no condensation within the battery pack 100) or optimal operating conditions within the battery pack 100. Further, the resistance 116 can serve as an additional heating element besides the one or more temperature control devices 614 (e.g., PTC heaters). This dual functionality allows the resistance 116 to contribute not only to electrical protection (e.g., preventing a load from being damaged by instantaneous high current) but temperature regulation without the need for separate heating components. Additionally, repurposing the precharge circuit to function as an additional heating element does not introduce extra cost or increase a size of the battery pack 100. Since the resistance 116 is already part of the precharge device circuit 102, leveraging the resistance 116 for heating and environment regulation purposes does not require additional components or modifications to the battery pack's design, thus maintaining the compactness and cost-effectiveness of the battery pack 100. In some examples, the precharge device circuit 102 can be used to reduce a charge rate of a downstream capacitor (e.g., the capacitor 204), and can also be used to modify or adjust an ambient temperature within the battery enclosure 704.

### Example Temperature and Humidity Control Process

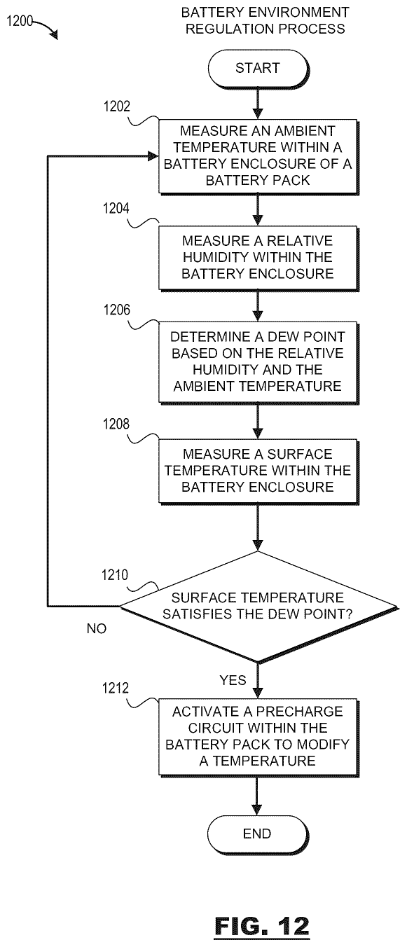

FIG. 12 illustrates an example battery environment regulation process 1200 in accordance with certain embodiments. The battery environment regulation process 1200 may be performed to control temperature and/or humidity associated with the battery pack 100 and the battery pack circuit 200. For example, the battery environment regulation process 1200 may be performed by the battery pack 100 (e.g., the battery management unit 130, the environment management system 506 and the precharge device circuit 102) to control an ambient temperature within the battery enclosure 704 of the battery pack 100, and/or a temperature within the battery pack 100. By at least controlling the ambient temperature, the battery environment regulation process 1200 may regulate humidity within a battery pack to prevent condensation and ensure better or optimal operating conditions within the battery pack 100. The battery environment regulation process 1200 may be performed continually, in response to a command (e.g., received from the user interface 502), when a humidity associated with the battery pack 100 is above a particular threshold, when the battery pack 100 is performing a discharging process (e.g., is in use to power a system, such as a motor), when the battery pack 100 is performing a charging process, when an external temperature is below a particular threshold, and/or in response to any other type of trigger that may cause the battery pack 100 to control an ambient temperature of an internal cavity of the battery pack 100.

The battery environment regulation process 1200 may begin at the block 1202 where, for example, the battery pack 100 measures an ambient temperature within the battery enclosure 704 of the battery pack 100. More specifically, the one or more temperature sensors 610 may measure the ambient temperature within the battery enclosure 704 of the battery pack 100. The one or more temperature sensors 610 may be positioned within the battery enclosure 704 to measure the ambient temperature of the air surrounding the battery cells for generating one or more temperature signals to indicate the ambient temperature. As noted above, the ambient temperature may refer to the temperature of an internal cavity or open space within the battery pack 100. In some examples, the ambient temperature may be distinct from a temperature of one or more elements within the battery pack 100, such as the one or more battery modules 110, battery cells, or terminals of the battery cells. In some examples, the ambient temperature may correspond to an aggregate or average of a plurality of temperature signals corresponding to a plurality of temperature readings taken within a particular time period (e.g., every 5 seconds over a minute time period, or every second over a 5 second time period, etc.).

At block 1204, the battery environment regulation process 1200 involves measuring a relative humidity within the battery enclosure 704. For example, the one or more humidity sensors 612 (e.g., relative humidity sensors) may measure the relative humidity within the battery enclosure 704 of the battery pack 100. The one or more humidity sensors 612 may be positioned within the battery enclosure 704 to generate data for indicating moisture or humidity of the air within the battery enclosure 704. In some examples, the relative humidity may correspond to an aggregate or average of a plurality of humidity signals corresponding to a plurality of humidity readings taken within a particular time period (e.g., every 5 seconds over a minute time period, or every second over a 5 second time period, etc.).

At block 1206, the battery pack 100 may determine a dew point based on the relative humidity and the ambient temperature. For example, based on the ambient temperature measured by the one or more temperature sensors 610 and the relative humidity measured by the one or more humidity sensors 612, the battery management unit 130 may determine the dew point. As noted above, the dew point may be the temperature at which air becomes saturated with moisture and condensation begins to form. The battery management unit 130 may determine or calculate the dew point using certain mathematical formulations that take the relative humidity and the ambient temperature into consideration. Additionally, and optionally, the battery management unit 130 may calculate the dew point based on an altitude of the battery pack 100. The altitude may be determined from an altimeter, which may be included in the battery pack and/or within a vehicle that includes the battery pack. Alternatively, or in addition, the altitude may be estimated based on a satellite positioning system (e.g., a global positioning system (GPS)) measurement. In some cases, the altitude may be a parameter provided during configuration of the battery pack or a vehicle that includes the battery pack by, for example, a user. In other examples, the battery management unit 130 may determine the dew point based at least in part on an environment temperature of an environment external to the battery pack 100. For example, the battery management unit 130 may calculate the dew point based on the ambient temperature, the relative humidity, and the environment temperature. The environment temperature may be provided by a temperature sensor external to the battery pack and/or as a configuration parameter provided by, for example, a user. As may be appreciated, the determination of the dew point can be useful for preventing condensation within the battery pack 100 to avoid damages caused to battery components.

At block 1208, the battery environment regulation process 1200 involves measuring a surface temperature within the battery enclosure 704. For example, the one or more temperature sensors 610 may measure the surface temperature within the battery enclosure 704. In some examples, the surface temperature may be a temperature of a wall of the battery enclosure 704, or a temperature of a battery cell of a plurality of battery cells of the battery pack 100. In some examples, the surface temperature may correspond to an aggregate or average of a plurality of temperature signals corresponding to a plurality of temperature readings taken within a particular time period (e.g., every 5 seconds over a minute time period, or every second over a 5 second time period, etc.).

At decision block 1210, the battery pack 100 determines whether the surface temperature measured at block 1208 satisfies the dew point determined or calculated at block 1206. More specifically, the battery management unit 130 may compare the surface temperature to the dew point to determine whether the surface temperature satisfies the dew point. In some examples, the battery management unit 130 may determine that the surface temperature satisfies the dew point when the surface temperature reaches the dew point. For example, assuming the dew point is 20° C., the battery management unit 130 may determine the surface temperature satisfied the dew point when the surface temperature drops to 20° C. In other examples, the battery management unit 130 may determine that the surface temperature satisfies the dew point when the surface temperature reaches to a certain threshold above the dew point. For example, the battery management unit 130 may determine that the surface temperature satisfies the dew point when the surface temperature is 0.25° C., 0.5° C., 1° C., 1.5° C., 2.0° C., 2.5° C., 3° C., 3.5° C., 4.0° C., 4.5° C., 5° C., 5.5° C., or 6.0° C. above the dew point.

If at decision block 1210 the battery management unit 130 determines that the surface temperature satisfies the dew point, the battery environment regulation process 1200 proceeds to block 1212. At block 1212, the battery pack 100 may activate a precharge circuit within the battery pack 100 to modify a temperature associated with the battery pack 100. For example, the battery management unit 130 may activate the precharge device circuit 102 to modify the temperature within the battery pack 100. As noted above, the precharge device circuit 102 may close the precharge relay switch 114, allowing current to flow through the resistance 116 to generate heat. This heat may raise the temperature (e.g., the ambient temperature of the battery enclosure 704) within the battery pack 100, thereby preventing condensation from forming and thereby protecting the battery components from moisture-related damage.

Advantageously, the precharge device circuit 102 can be activated in place of a separate or an additional heating element (e.g., the one or more temperature control devices 614), leveraging existing components (e.g., the resistance 116, the precharge relay switch 114) within the battery pack 100 to achieve the desired temperature and/or humidity regulation. As such, the number of heating elements that may be incorporated into the battery pack 100 can be reduced while maintaining the ability to prevent condensation from forming within the battery pack. This reduction in heating elements can help reduce the size and cost of the battery pack 100. Additionally, using the precharge device circuit 102 for regulating the temperature within the battery pack 100 may reduce implementation complexity associated with the battery pack 100. For example, in some cases it may be difficult to incorporate a heating element due to space restrictions or limitations. For instance, it may be difficult to insert a heating element at or near the PCB 702 of FIG. 7B due to the space being utilized by the PCB 702 and associated circuit components. Reusing the precharge device circuit 102 as the heating element enables a separate heating element to be omitted without reducing the effectiveness of the humidity or condensation regulation of the battery pack 100.

If at decision block 1210 the battery management unit 130 determines that the surface temperature does not satisfy the dew point, the battery environment regulation process 1200 may return back to block 1202, where the battery environment regulation process 1200 may be iterated automatically or responsive to an occurrence of a triggering condition.

Advantageously, the battery environment regulation process 1200 may ensure that the battery pack 100 operates under optimal conditions by dynamically adjusting the temperature and humidity levels within the battery enclosure 704. This regulation helps to prevent condensation and maintain the performance and longevity of the battery cells of the battery pack 100 at little or no additional cost at least because of the use of the precharge device circuit 102 in place of a separate heating element (e.g., the one or more temperature control devices 614).

Although not illustrated in FIG. 12, in some examples, the battery environment regulation process 1200 may return to block 1202 from block 1212 for deactivating a precharge circuit of the battery pack 100. For example, after activating the precharge device circuit 102 (e.g., closing the precharge relay switch 114 to use the resistance 116 to generate heat) at a first time to modify a temperature of the battery pack 100, the battery pack 100 may perform the battery environment regulation process 1200 at a second time later than the first time. More specifically, the battery pack 100 may measure the ambient temperature within the battery enclosure 704 at the second time, measure the relative humidity within the battery enclosure 704, determine the dew point based on the relative humidity and the ambient temperature measured at the second time, and measure a surface temperature within the battery enclosure 704. If the battery pack 100 determines, at the second time, that the surface temperature does not satisfy the dew point, the battery pack 100 may deactivate the precharge device circuit 102 of the battery pack 100.

### Example Heating Elements Activation

In some examples, instead of using a battery to power heating elements, the battery pack 100 may use shore power, mains power, or power from a charger (e.g., a wall charger) to power or activate the one or more temperature control devices 614 (e.g., the PTC heating elements), especially when the battery pack 100 is operating under low temperature. As may be appreciated, using shore power to power heating elements in the battery pack 100 may involve connecting the battery pack 100 to an external power source, such as a charger on a wall or other power sources available at charging stations or designated areas. This external power source may provide electrical energy to operate the PTC heating elements within the battery pack 100, achieving improved temperature conditions for the battery cells. When using shore power to power the PTC heating elements of the battery pack 100, the battery pack 100 may dynamically allocate shore power between activating the PTC heating elements and charging the battery cells. This helps to ensure that the battery pack 100 operates under more favorable temperature (e.g., not too cold) and that battery cells can be charged more efficiently.

For example, when the battery pack 100 is first connected to shore power, ambient temperature of the battery pack 100 may be around −4° C. The battery pack 100 may use the shore power received through a main line of the battery pack 100 to activate the PTC heating elements for generating heat. In contrast to situations where PTC heating elements are solely activated by power from the battery cells of the battery pack 100, battery charge of the battery cells of the battery pack 100 may be preserved or less likely to be drained through utilizing shore power to activate the PTC heating elements.

When the ambient temperature of the battery pack 100 is raised to a certain threshold (e.g., 0° C.), the battery pack 100 may start utilizing at least some portions of the shore power to charge the battery cells of the battery pack 100. Meanwhile, the battery pack 100 may keep utilizing remaining portions of the shore power to activate the PTC heating elements for continually generating heat to increase or maintain the ambient temperature of the battery pack 100. Advantageously, charging the battery cells of the battery pack 100 under temperature that is above a temperature threshold helps to ensure optimal battery performance and prevent issues related to battery operations under low temperatures, such as reduced efficiency and increased internal resistance associated with the battery pack 100.

### Additional Examples

Some additional nonlimiting examples of the present disclosure are discussed below in the following clauses. The below clauses should not be read as limiting the breadth of the disclosure, but are provided as additional examples.

Clause 1. A temperature control system for regulating temperature inside a battery pack, the temperature control system comprising: a heating element configured to raise a temperature of an ambient environment within a battery enclosure of the battery pack; a first temperature sensor configured to measure a first temperature of the ambient environment at a first measurement location within the battery enclosure, wherein the first temperature sensor is attached to a first attachment location within the battery enclosure and at a first distance away from a plurality of battery cells of the battery pack; a second temperature sensor configured to measure a second temperature of the ambient environment at a second measurement location within the battery enclosure, wherein the second temperature sensor is attached to a second attachment location within the battery enclosure and at a second distance away from the plurality of battery cells of the battery pack; and a controller configured to: receive a first temperature signal from the first temperature sensor at a first time, wherein the first temperature signal corresponds to a first temperature of the ambient environment at the first time and at the first measurement location; receive a second temperature signal from the second temperature sensor at the first time, wherein the second temperature signal corresponds to a second temperature of the ambient environment at the first time and at the second measurement location; determine an average ambient temperature based at least in part on the first temperature signal and the second temperature signal; compare the average ambient temperature to a threshold temperature value to obtain a comparison result; and based at least in part on the comparison result, activate the heating element to raise the temperature of the ambient environment within the battery enclosure from the average ambient temperature to a target temperature.

Clause 2. The temperature control system of clause 1, further comprising a third temperature sensor configured to measure temperature of an external ambient environment outside of the battery enclosure.

Clause 3. The temperature control system of clause 2, wherein the controller is further configured to activate the heating element based at least in part on a comparison of a temperature of the external ambient environment and an ambient threshold temperature value.

Clause 4. The temperature control system as in any one of clauses 1-3, wherein the controller is further configured to maintain the temperature of the ambient environment within a target temperature range.

Clause 5. The temperature control system of clause 4, wherein the target temperature range is between 20 to 35 degrees Celsius.

Clause 6. The temperature control system as in clause 4 or clause 5, wherein the target temperature range corresponds to a temperature range of the plurality of battery cells of the battery pack.

Clause 7. The temperature control system as in any one of clauses 1-6, wherein the heating element comprises a positive temperature coefficient (PTC) heater.

Clause 8. The temperature control system as in any one of clauses 1-7, wherein the heating element comprises a plurality of heating elements distributed throughout the battery enclosure of the battery pack.

Clause 9. The temperature control system of clause 8, wherein at least one heating element is affixed to a side plate of the battery enclosure.

Clause 10. The temperature control system as in clause 8 or clause 9, wherein at least one heating element is affixed to a top plate of the battery enclosure.

Clause 11. The temperature control system as in any one of clauses 8-10, wherein the plurality of heating elements comprises two heating elements, and wherein a first heating element is affixed to a first side of the battery enclosure, and wherein a second heating element is affixed to a second side of the battery enclosure.

Clause 12. The temperature control system of clause 11, wherein the second side is opposite to the first side.

Clause 13. The temperature control system as in any one of clauses 1-12, wherein the heating element is affixed to an inside surface of the battery enclosure.

Clause 14. The temperature control system as in any one of clauses 1-13, wherein the threshold temperature value comprises a value between 5 to 15 degrees Celsius.

Clause 15. The temperature control system as in any one of clauses 1-14, wherein the controller is further configured to set the threshold temperature value based at least in part on an external ambient environment outside of the battery enclosure.

Clause 16. The temperature control system as in any one of clauses 1-15, wherein the threshold temperature value comprises a threshold temperature range, and wherein the controller is further configured to compare the average ambient temperature to the threshold temperature range.

Clause 17. The temperature control system of clause 16, wherein the comparison result indicates whether the average ambient temperature is within the threshold temperature range.

Clause 18. The temperature control system as in clause 16 or clause 17, wherein the target temperature comprises a temperature within the threshold temperature range.

Clause 19. The temperature control system as in any one of clauses 16-18, wherein the controller is further configured to deactivate the heating element when the temperature of the ambient environment is raised to a temperature within the threshold temperature range.

Clause 20. The temperature control system as in any one of clauses 16-19, wherein the threshold temperature range is between 5 to 15 degrees Celsius.

Clause 21. The temperature control system as in any one of clauses 1-20, wherein the controller is further configured to: receive a third temperature signal from the first temperature sensor at a second time, wherein the third temperature signal corresponds to a third temperature of the ambient environment at the second time and at the first measurement location; receive a fourth temperature signal from the second temperature sensor at the second time, wherein the fourth temperature signal corresponds to a fourth temperature of the ambient environment at the second time and at the second measurement location; determine a second average ambient temperature based at least in part on the third temperature signal and the fourth temperature signal; compare the second average ambient temperature to the threshold temperature value to obtain a second comparison result; and based at least in part on the second comparison result, deactivate the heating element.

Clause 22. The temperature control system of clause 21, wherein the threshold temperature value comprises a temperature range, wherein comparing the average ambient temperature to the threshold temperature value comprises comparing the average ambient temperature to a minimum value of the temperature range, and wherein comparing the second average ambient temperature to the threshold temperature value comprises comparing the second average ambient temperature to a maximum value of the temperature range.

Clause 23. The temperature control system as in any one of clauses 1-22, wherein the controller comprises a battery management system.

Clause 24. The temperature control system as in any one of clauses 1-23, further comprising a thermal conductive gel on at least one side of the heating element.

Clause 25. The temperature control system as in any one of clauses 1-24, further comprising an isolation protrusion bar positioned between the heating element and the battery enclosure to prevent contact between the heating element and the battery enclosure.

Clause 26. The temperature control system as in any one of clauses 1-25, further comprising a heating relay configured to apply a current to the heating element when the controller activates the heating element.

Clause 27. The temperature control system as in any one of clauses 1-26, wherein the heating element is further configured to control humidity within the battery pack.

Clause 28. The temperature control system as in any one of clauses 1-27, wherein the first temperature sensor is positioned to measure the first temperature of the ambient environment without measuring a temperature of the plurality of battery cells.

Clause 29. The temperature control system as in any one of clauses 1-28, wherein the first attachment location is separated from the second attachment location by a minimum distance.

Clause 30. The temperature control system as in any one of clauses 1-29, wherein the first measurement location is separated from the second measurement location by a minimum distance.

Clause 31. The temperature control system as in any one of clauses 1-30, wherein the first measurement location is at a first side of the battery pack and wherein the second measurement location is at a second side of the battery pack.

Clause 32. The temperature control system as in any one of clauses 1-31, wherein the first distance and the second distance are the same distance.

Clause 33. The temperature control system as in any one of clauses 1-32, wherein the first distance and the second distance are each at least a minimum distance away from the plurality of battery cells of the battery pack.

Clause 34. A battery pack configured to power an electric vehicle, the battery pack comprising: a plurality of battery cells configured to store a charge and power a motor of the electric vehicle; a battery enclosure configured to house at least the plurality of battery cells; and a temperature control system stored within the battery enclosure and configured to regulate ambient temperature inside the battery enclosure, the temperature control system comprising: a heating element configured to raise the ambient temperature within the battery enclosure; a temperature sensor configured to measure the ambient temperature within the battery enclosure, wherein the temperature sensor is positioned to measure the ambient temperature without measuring a temperature of the plurality of battery cells; and a controller configured to: receive a temperature signal from the temperature sensor at a first time, wherein the temperature signal corresponds to the ambient temperature within the battery enclosure at the first time; compare the ambient temperature to a threshold temperature value based at least in part on the temperature signal to obtain a comparison result; and based at least in part on the comparison result, activate the heating element to raise the ambient temperature within the battery enclosure at a second time.

Clause 35. A method of regulating temperature inside a battery pack, the method comprising: by a controller of the battery pack, receiving a temperature signal from a temperature sensor at a first time, wherein the temperature signal corresponds to an ambient temperature within a battery enclosure of the battery pack at the first time; comparing the ambient temperature, based at least in part on the temperature signal, to a threshold temperature value to obtain a comparison result; and based at least in part on the comparison result, activating a heating element to raise the ambient temperature within the battery enclosure at a second time without modifying heat applied to a plurality of cells of the battery pack.

Clause 36. A battery pack configured to precharge a load, the battery pack comprising: a battery module configured to electrically connect to the load that is powered by the battery module; a positive relay switch electrically connected between a positive node of the battery module and the load; a precharge relay switch electrically connected between the positive node of the battery module and the load, wherein the precharge relay switch is connected in parallel with the positive relay switch; a precharge resistor connected between the precharge relay switch and the positive node of the battery module; and a negative relay switch electrically connected between a negative node of the battery module and the load, wherein the precharge relay switch and the negative relay switch are set to a closed state and the positive relay switch is set to an opened state when an electrical connection to the load is detected at a first time, and wherein the precharge relay switch is set to an opened state and the positive relay switch is set to a closed state at a second time.

Clause 37. The battery pack of clause 36, wherein the first time occurs at a point in time when the load is first electrically connected to the battery pack after not being electrically connected to the battery pack.

Clause 38. The battery pack as in clause 36 or clause 37, wherein the second time occurs a fixed period of time after the first time.

Clause 39. The battery pack of clause 38, wherein the fixed period of time is 0.5 seconds.

Clause 40. The battery pack as in any one of clauses 36-39, wherein the second time occurs when a difference between a voltage across the load and a voltage of the battery module satisfies a threshold difference.

Clause 41. The battery pack as in any one of clauses 36-40, wherein the second time occurs a fixed period of time after a difference between a voltage across the load and a voltage of the battery module satisfies a threshold difference.

Clause 42. The battery pack of clause 41, wherein the fixed period of time is 0.5 seconds.

Clause 43. The battery pack as in any one of clauses 36-42, wherein the battery module is one of a plurality of battery modules connected in series.

Clause 44. The battery pack as in any one of clauses 36-43, wherein the battery module comprises at least one battery cell.

Clause 45. The battery pack as in any one of clauses 36-44, wherein the load comprises a capacitor.

Clause 46. The battery pack of clause 45, wherein the capacitor is part of a motor controller powered by the battery pack.

Clause 47. The battery pack of clause 45, wherein the capacitor is part of an air conditioning unit powered by the battery pack.

Clause 48. The battery pack as in any one of clauses 36-47, wherein the second time is later than the first time.

Clause 49. The battery pack as in any one of clauses 36-48, further comprising a charge relay switch electrically connected between a load and the positive node of the battery module, wherein the precharge relay switch and the positive relay switch are set to an opened state and the negative relay switch and the charge relay switch are set to a closed state when an electrical connection to a battery charging system is detected.

Clause 50. The battery pack of clause 49, wherein the electrical connection to the battery charging system is detected based on a handshaking process between a battery management unit of the battery pack and the battery charging system.

Clause 51. The battery pack as in any one of clauses 36-50, further comprising a battery management unit configured to determine when a difference between a voltage across the load and a voltage of the battery module satisfies a threshold difference.

Clause 52. An electric vehicle comprising: a motor; and a battery pack configured to power the motor, the battery pack comprising: a battery module configured to electrically connect to a capacitor of the motor; a positive relay switch electrically connected between a positive node of the battery module and the capacitor; a precharge relay switch electrically connected between the positive node of the battery module and the capacitor, wherein the precharge relay switch is connected in parallel with the positive relay switch; a precharge resistor connected between the precharge relay switch and the positive node of the battery module; and a negative relay switch electrically connected between a negative node of the battery module and the capacitor, wherein the precharge relay switch and the negative relay switch are set to a closed state and the positive relay switch is set to an opened state when an electrical connection to the capacitor is detected at a first time, and wherein the precharge relay switch is set to an opened state and the positive relay switch is set to a closed state at a second time.

Clause 53. The electric vehicle of clause 52, wherein the first time occurs at a point in time when the motor is first electrically connected to the battery pack after not being electrically connected to the battery pack enabling power to be supplied from the battery pack to the motor.

Clause 54. The electric vehicle as in clause 52 or clause 53, wherein the second time occurs during one of: a fixed period of time after the first time; when a difference between a voltage across the capacitor and a voltage of the battery module satisfies a threshold difference; or a fixed period of time after the difference between the voltage across the capacitor and the voltage of the battery module satisfies the threshold difference.

Clause 55. The electric vehicle as in any one of clauses 52-54, wherein the capacitor is part of a capacitor bank of a motor controller configured to control operation of the motor.

Clause 56. The electric vehicle as in any one of clauses 52-55, wherein the capacitor is part of a motor controller of the motor.

Clause 57. The electric vehicle as in any one of clauses 52-56, wherein the battery pack further comprises a charge relay switch electrically connected between a load and the positive node of the battery module, wherein the precharge relay switch and the positive relay switch are set to an opened state, and the negative relay switch and the charge relay switch are set to a closed state when an electrical connection to a battery charging system is detected.

Clause 58. The electric vehicle of clause 57, wherein the electrical connection to the battery charging system is detected based on a handshaking process between a battery management unit of the battery pack and the battery charging system.

Clause 59. The electric vehicle as in any one of clauses 52-58, wherein the battery pack further comprises a battery management unit configured to determine when a difference between a voltage across the capacitor and a voltage of the battery module satisfies a threshold difference.

Clause 60. A method of discharging a battery pack to power a load of an electric vehicle, the method comprising: determining that the battery pack has been connected at a first time to a load of the electric vehicle; responsive to the determination at the first time: maintaining in an open position a charge relay switch positioned between a positive node of a battery module of the battery pack and a port configured to electrically connect to a battery charging system; maintaining in a closed position a precharge relay switch positioned between a precharge resistor and the load of the electric vehicle, wherein the precharge resistor is positioned between the precharge relay switch and the positive node of the battery module; maintaining in an open position a positive relay switch positioned in parallel with the precharge relay switch and connected between the positive node of the battery module and the load of the electric vehicle; and maintaining in a closed position a negative relay switch connected between the load of the electric vehicle and a negative node of the battery module; determining at a second time that a trigger condition has been satisfied; and in response to determining that the trigger condition has been satisfied, opening the precharge relay switch and closing the positive relay switch.

Clause 61. The method of clause 60, wherein the trigger condition comprises one of: passage of a fixed period of time after the first time; a difference between a voltage at the load and a voltage of the battery module satisfies a threshold difference; or passage of a fixed period of time after the difference between the voltage at the load and the voltage of the battery module satisfies the threshold difference.

Clause 62. The method as in clause 60 or clause 61, wherein, responsive to the determination at the first time, the method further comprises: opening the charge relay switch; closing the precharge relay switch; opening the positive relay switch; and closing the negative relay switch.

Clause 63. The method as in any one of clauses 60-62, wherein the determining that the battery pack has been connected at the first time to the load comprises performing a handshaking process between a battery management unit and the electric vehicle.

Clause 64. The method as in any one of clauses 60-63, further comprising: determining at a third time and based on a handshaking process that the battery pack is electrically connected to the battery charging system; and in response to determining that the battery pack is electrically connected to the battery charging system: opening the positive relay switch; opening the precharge relay switch; closing the charge relay switch; and closing the negative relay switch enabling the battery charging system to charge the battery pack.

### Terminology

Conditional language used herein, such as, among others, “can,” “could,” “might,” “may,” “e.g.,” and the like, unless specifically stated otherwise, or otherwise understood within the context as used, may be generally intended to convey that certain embodiments include, while other embodiments do not include, certain features, elements and/or states. Thus, such conditional language may be not generally intended to imply that features, elements and/or states may be in any way required for one or more embodiments or that one or more embodiments necessarily include these features, elements and/or states.

Conjunctive language such as the phrase “at least one of X, Y, and Z,” unless specifically stated otherwise, may be otherwise understood with the context as used in general to convey that an item, term, etc. may be either X, Y, or Z. Thus, such conjunctive language may be not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Additionally, features described in connection with one embodiment can be incorporated into another of the disclosed embodiments, even if not expressly discussed herein, and embodiments may have the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it may be intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example may be to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps may be mutually exclusive. The protection may be not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

Moreover, while operations may be depicted in the drawings or described in the specification in a particular order, such operations need not be performed in the particular order shown or in sequential order, or that all operations be performed, to achieve desirable results. Other operations that may be not depicted or described can be incorporated in the example methods and processes. For example, one or more additional operations can be performed before, after, simultaneously, or between any of the described operations. Further, the operations may be rearranged or reordered in other implementations, including being performed at least partially in parallel. Those skilled in the art will appreciate that in some embodiments, the actual steps taken in the processes illustrated and/or disclosed may differ from those shown in the figures. Depending on the embodiment, certain of the steps described above may be removed, others may be added.

For purposes of this disclosure, certain aspects, advantages, and novel features may be described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that may be within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure may be not intended to be limited by the specific disclosures of preferred embodiments in this section or elsewhere in this specification, and may be defined by claims as presented in this section or elsewhere in this specification or as presented in the future. The language of the claims may be to be interpreted broadly based on the language employed in the claims and not limited to the examples described in the present specification or during the prosecution of the application, which examples may be to be construed as non-exclusive.

Unless the context clearly may require otherwise, throughout the description and the claims, the words “comprise”, “comprising”, and the like, may be construed in an inclusive sense as opposed to an exclusive or exhaustive sense, that may be to say, in the sense of “including, but not limited to”.

What is claimed is:

1. A temperature control system for regulating temperature inside a battery pack that comprises a precharge circuit configured to protect low-voltage components during application of the battery pack to a load, the temperature control system comprising:
a temperature sensor configured to measure ambient temperature within a battery enclosure of the battery pack, wherein the temperature sensor is positioned to measure the ambient temperature without measuring a temperature of a plurality of battery cells of the battery pack;
a humidity sensor configured to measure humidity within the battery enclosure; and
a controller configured to:
receive a first temperature signal from the temperature sensor at a first time, wherein the first temperature signal corresponds to the ambient temperature measured by the temperature sensor;
receive a first humidity signal from the humidity sensor, wherein the first humidity signal corresponds to the humidity measured by the humidity sensor;
determine a first dew point based at least in part on the first temperature signal and the first humidity signal;
determine based at least in part on the first dew point whether a heater threshold is satisfied; and
in response to determining that the heater threshold is satisfied, activate the precharge circuit of the battery pack, wherein the precharge circuit modifies a temperature within the battery pack in place of a separate heating element.

2. The temperature control system of claim 1, wherein the controller is further configured to:
receive a second temperature signal from the temperature sensor at a second time, wherein the second temperature signal corresponds to the ambient temperature measured by the temperature sensor;
receive a second humidity signal from the humidity sensor, wherein the second humidity signal corresponds to the humidity measured by the humidity sensor;
determine a second dew point based at least in part on the second temperature signal and the second humidity signal;
determine based at least in part on the second dew point whether the heater threshold is satisfied; and
in response to determining that the heater threshold is not satisfied, deactivate the precharge circuit of the battery pack.

3. The temperature control system of claim 1, wherein the controller is further configured to determine whether the heater threshold is satisfied based on the first dew point by determining whether a surface temperature in the battery pack satisfies the first dew point.

4. The temperature control system of claim 1, further comprising a second temperature sensor configured to measure a battery cell temperature of a battery cell within the battery enclosure.

5. The temperature control system of claim 4, wherein the controller is further configured to:
receive a second temperature signal from the second temperature sensor at the first time, wherein the second temperature signal corresponds to the battery cell temperature measured by the second temperature sensor; and
determine based at least in part on the first dew point and the second temperature signal whether the heater threshold is satisfied.

6. The temperature control system of claim 1, further comprising a third temperature sensor configured to measure an environment temperature external to the battery pack.

7. The temperature control system of claim 6, wherein the controller is further configured to:
receive a third temperature signal from the third temperature sensor at the first time, wherein the third temperature signal corresponds to the environment temperature measured by the third temperature sensor; and
determine based at least in part on the first dew point and the third temperature signal whether the heater threshold is satisfied.

8. The temperature control system of claim 1, wherein the controller is further configured to determine whether the heater threshold is satisfied based at least in part on the first temperature signal, the first humidity signal, and a battery cell temperature.

9. The temperature control system of claim 1, wherein the controller is further configured to determine whether the heater threshold is satisfied based at least in part on the first temperature signal, the first humidity signal, and an environment temperature external to the battery pack.

10. The temperature control system of claim 1, wherein the humidity sensor is configured to measure relative humidity and wherein the humidity measured by the humidity sensor comprises relative humidity.

11. A battery pack configured to power an electric vehicle, the battery pack comprising:
a plurality of battery cells configured to store a charge and power a motor of the electric vehicle;
a battery enclosure configured to house at least the plurality of battery cells;
a precharge circuit configured to reduce a charge rate of a downstream capacitor;
an ambient temperature sensor configured to measure ambient temperature within the battery enclosure;
a relative humidity sensor configured to measure a relative humidity within the battery enclosure; and
a controller configured to:
determine, at a first time, a dew point based at least in part on the relative humidity and the ambient temperature;
determine whether a surface temperature within the battery enclosure satisfies the dew point; and
in response to determining that the surface temperature satisfies the dew point, activate the precharge circuit to modify the ambient temperature.

12. The battery pack of claim 11, wherein the precharge circuit modifies the ambient temperature in place of a separate heating element.

13. The battery pack of claim 11, further comprising a surface temperature sensor configured to measure the surface temperature within the battery enclosure.

14. The battery pack of claim 11, wherein the surface temperature is a temperature of a wall of the battery enclosure.

15. The battery pack of claim 11, wherein the surface temperature is a temperature of a battery cell of the plurality of battery cells.

16. The battery pack of claim 11, further comprising an environment temperature sensor configured to measure an environment temperature of an environment external to the battery pack.

17. The battery pack of claim 16, wherein the controller is further configured to determine the dew point based at least in part on the environment temperature.

18. The battery pack of claim 11, wherein the controller is further configured to:
determine, at a second time that is later than the first time, a second dew point based at least in part on a second relative humidity and a second ambient temperature;
determine whether a second surface temperature within the battery enclosure satisfies the second dew point; and
in response to determining that the second surface temperature does not satisfy the second dew point, deactivate the precharge circuit.

19. A method of regulating a battery pack, the method comprising:
by a controller within the battery pack,
measuring an ambient temperature within a battery enclosure of the battery pack using an ambient temperature sensor within the battery enclosure;
measuring a relative humidity within the battery enclosure;
determining a dew point based at least in part on the relative humidity and the ambient temperature;
measuring a surface temperature within the battery enclosure, wherein the surface temperature corresponds to a temperature of a surface within the battery enclosure;
determining whether the surface temperature satisfies the dew point; and
in response to determining that the surface temperature satisfies the dew point, activating a precharge circuit within the battery pack, wherein the precharge circuit is activated to modify a temperature.

20. The method of claim 19, wherein the precharge circuit is used in place of at least one heating element, and wherein the at least one heating element is omitted from the battery pack.
